(19) United States
(12) Patent Application Publication
(10) Pub. No.: US 2023/0387613 A1
(43) Pub. Date: Nov. 30, 2023

(54) CONNECTOR WITH CAPTIVE INTERFACE

(71) Applicant: Burndy, LLC, Manchester, NH (US)

(72) Inventors: Charles L. York, III, Bow, NH (US); Gary E. Schrader, III, Manchester, NH (US); Spencer Ralphs, Stoneham, MA (US)

(21) Appl. No.: 18/233,601

(22) Filed: Aug. 14, 2023

Related U.S. Application Data
(63) Continuation-in-part of application No. 18/082,686, filed on Dec. 16, 2022.
(60) Provisional application No. 63/290,593, filed on Dec. 16, 2021.
(60) Provisional application No. 63/291,041, filed on Dec. 17, 2021.

(51) Int. Cl. H01R 4/50

(52) U.S. Cl. CPC H01R 4/5091

(57) ABSTRACT

An interface for use with a wedge type cable connector, the interface includes a body having first and second longitudinal side walls and upper and lower concave longitudinal contact surfaces, wherein the lower concave longitudinal contact surface includes a convex longitudinal bump.

### CROSS-REFERENCE TO RELATED APPLICATIONS

The present disclosure is a continuation-in-part of U.S. patent application Ser. No. 18/082,686 filed on Dec. 16, 2022 entitled “Connector with Captive Interface” which is based on and claims benefit from U.S. Provisional Patent Application Ser. No. 63/290,593 filed on Dec. 16, 2021 entitled “Connector with Captive Interface” and from U.S. Provisional Application Ser. No. 63/291,041 filed on Dec. 17, 2021 entitled “Connector with Captive Interface” the contents of each are incorporated herein in their entirety by reference.

### BACKGROUND

### Field

The present disclosure relates generally to electrical connectors. More particularly, the present disclosure relates to wedge type electrical connectors and interfaces adapted to electrically and mechanically interconnect main conductors and tap conductors.

### Description of the Related Art

Wedge type electrical connector assemblies are known in the art. Electrical connectors may be adapted to electrically and mechanically connect conductors within a transmission or distribution circuit. For example, a typical electrical connector may be used to connect a main conductor to a tap conductor. An electrical connector adapted to connect a main conductor or a tap conductor to another conductor may be referred to as a tap connector. Wedge type tap connectors typically include a C-shaped body having a curved top wall adapted to fit over a main conductor. A bolt-operated wedge is carried by the bottom of the C-shaped body and may include an elongated recess in the top for supporting the tap conductor. A conductor interface has a handle thereon which allows the interface to be placed within the C-shaped connector body between the conductors. A bolt positively moves the wedge both in and out of the C-shaped body so that the clamping action of the connector can be tightened or loosened as desired.

However, during the clamping process, there may be instances where the strands forming the conductor begins to separate or unravel. A need exists to minimize or prevent such separation or unraveling.

### SUMMARY

The present disclosure provides exemplary embodiments of interfaces for use with a wedge type cable connector, the interface includes a body having first and second longitudinal side walls and upper and lower concave longitudinal contact surfaces, wherein the lower concave longitudinal contact surface includes a convex longitudinal bump.

The present disclosure also provides a wedge type electrical power connector assembly including a frame having conductor contact wall, a wedge support wall, and a rear wall between the conductor contact wall and the wedge support wall and a mounting member, wherein the conductor contact wall, the wedge support wall and the rear wall form a wedge receiving channel. A wedge assembly has a wedge and a fastener, the wedge having a body and a fastener holder, the body being shaped to fit at least partially within the wedge receiving channel of the frame, the fastener holder being aligned with the mounting member so that the fastener can pass through the fastener holder into engagement with the mounting member. An interface is movably positioned within the wedge receiving channel, the interface including a body having first and second longitudinal side walls and upper and lower concave longitudinal contact surfaces, wherein the lower concave longitudinal contact surface includes a convex longitudinal bump.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is the front elevation view of the wedge type electrical cable connector assembly, illustrating the main conductor secured to the cable connector assembly and a tap conductor positioned between the wedge assembly and a conductor interface;

FIG. 2 is an exploded perspective view of the wedge type electrical cable connector assembly of FIG. 1, illustrating a wedge assembly, a frame, a conductor interface and a connecting member used to mate the conductor interface to the frame;

FIG. 3 is a front elevation view of the frame of the wedge type electrical cable connector assembly of FIG. 2;

FIG. 4 is the enlarged local end elevation view of a portion of the wedge type electrical cable connector assembly of FIG. 1, illustrating a tap conductor secured between the cable interface and the wedge assembly;

FIG. 5 is a partial front elevation view of a wedge type electrical cable connector assembly, illustrating a main conductor secured between the conductor contact wall and the conductor interface and the tap conductor positioned between the wedge assembly and the conductor interface according to an illustrative embodiment of the present disclosure;

FIG. 6 is the enlarged local end elevation view of a portion of the wedge type electrical cable connector assembly of FIG. 5, illustrating the tap conductor secured between the wedge assembly and the conductor interface according to an illustrative embodiment of the present disclosure;

FIG. 7 is a first side perspective view of an exemplary embodiment of a conductor interface according to an illustrative embodiment of the present;

FIG. 8 is a second side perspective view of the conductor interface of FIG. 7;

FIG. 9 is a first end elevation view of the conductor interface of FIG. 7;

FIG. 10 is a second end elevation view of the conductor interface of FIG. 7;

FIGS. 11A-11Z1 are end elevation views of conductor interfaces according to various illustrative embodiments of the present disclosure;

FIG. 12 is an end elevation view of the wedge type electrical cable connector assembly of FIG. 1, illustrating a main conductor positioned for insertion into the cable connector assembly;

FIG. 13 is the end elevation view of the wedge type electrical cable connector assembly of FIG. 12, illustrating the main conductor being inserted into the cable connector assembly;

FIG. 14 is the end elevation view of the wedge type electrical cable connector assembly of FIG. 12, illustrating the main conductor positioned between the conductor contact wall and the conductor interface of the cable connector assembly;

FIG. 15 is an end elevation view of the wedge type electrical cable connector assembly of FIG. 1, illustrating a tap conductor positioned for insertion into the cable connector assembly;

FIG. 16 is the end elevation view of the wedge type electrical cable connector assembly of FIG. 15, illustrating the tap conductor being inserted into the cable connector assembly; and

FIG. 17 is the end elevation view of the wedge type electrical cable connector assembly of FIG. 15, illustrating the tap conductor positioned between the conductor contact wall and the conductor interface of the cable connector assembly.

### DETAILED DESCRIPTION

The present disclosure provides exemplary embodiments of improved conductor interfaces for use in electrical cable connectors adapted to electrically and mechanically connect conductors within transmission or distribution circuits.

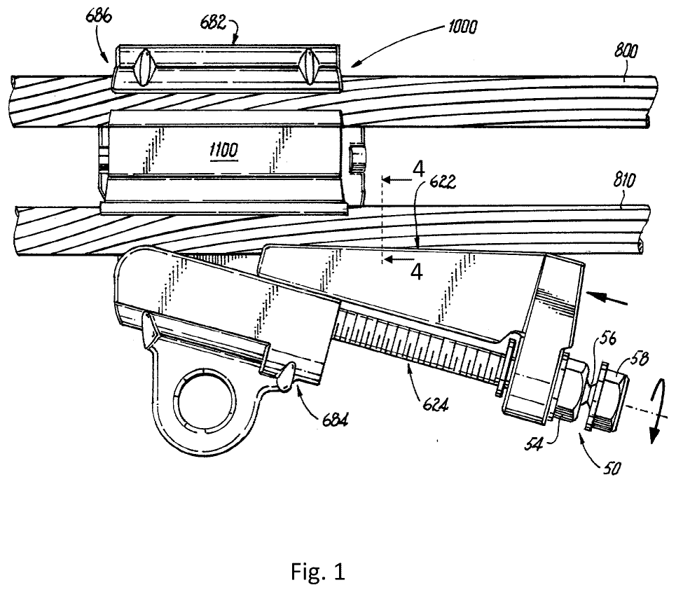

The wedge type electrical cable connectors contemplated by the present disclosure include, but are not limited to, wedge type tap connectors. Wedge type tap connectors electrically and mechanically connect a main conductor to a tap conductor, as shown in FIG. 1. The wedge type electrical cable connectors according to the present disclosure flexibly mate a conductor interface with a frame of the wedge type electrical cable connector using one or more flex connecting members to facilitate easier installation of the wedge type electrical cable connector using extendable reach tools. For ease of description, the wedge type electrical cable connectors contemplated by the present disclosure may also be referred to herein as the “connectors” in the plural and the “connector” in the singular. The conductor interfaces contemplated by the present disclosure may also be referred to herein as the “interfaces” in the plural and the “interface” in the singular. The flex connecting members contemplated by the present disclosure may also be referred to herein as the “connecting members” in the plural and the “connecting member” in the singular. The main conductors referenced herein include, for example, transmission line conductors, and the tap conductors referenced herein include, for example, branch conductors. For general reference purposes, a main conductor supplies power from either a transmission circuit or a distribution circuit, and a tap conductor distributes power to a distribution circuit or a load.

An exemplary wedge type tap connector is shown in FIGS. 1-3 and may be used to connect a main conductor 800 electrically and mechanically to a tap conductor 810 and is referred to as connector 1000. The connector 1000 includes a wedge assembly 1030, a frame 1050 and one or more connecting members 750. An interface 1100 may be secured to frame 1050 utilizing the one or more connecting members 750.

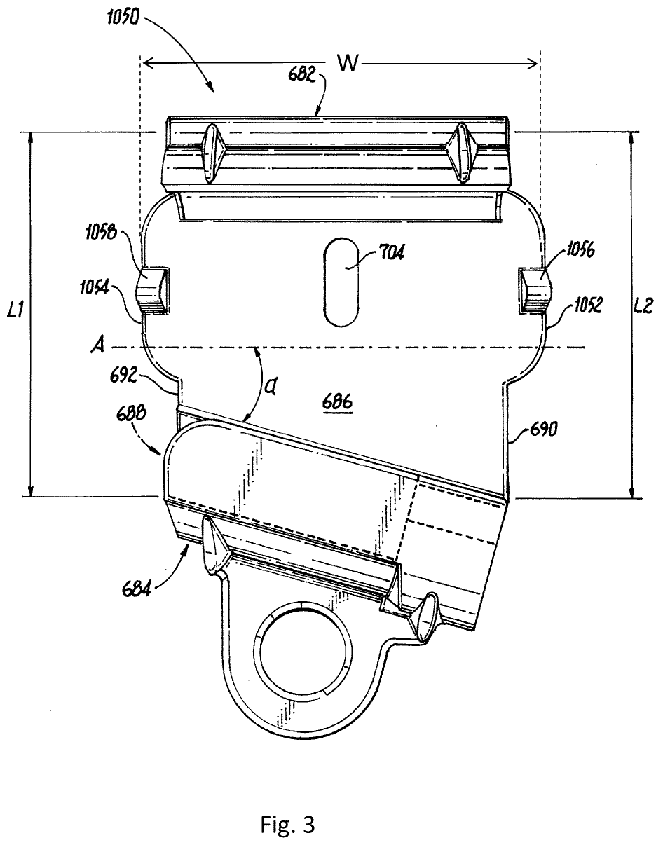

Frame 1050 is a C-shaped like body or member. The frame 1050 has a conductor contact wall 682, a wedge support wall 684, and a rear wall 686 between the conductor contact wall 682 and the wedge support wall 684. Between the conductor contact wall 682, the wedge support wall 684 and the rear wall 686 is a wedge receiving channel 688. The wedge receiving channel 688 at a first end 690 of the rear wall 686 has a length “L1” and the wedge receiving channel 688 at a second end 692 of the rear wall 686 has a length “L2” seen in FIG. 3. In the embodiment shown, the length “L1” may be less than the length “L2” such that one or both of the conductor contact wall 682 and the wedge support wall 684 are tapered relative to a longitudinal axis “A” of the frame 970. In other embodiments, the length “L1” may be equal to or greater than the length “L2” such that one or both of the conductor contact wall 682 and the wedge support wall 684 are tapered relative to a longitudinal axis “A” of frame 970. In the embodiment shown, the wedge support wall 684 is at an angle “a” relative to a longitudinal axis “A” of the frame 970. The angle “a”, as seen in FIG. 3, may be in the range of about 5 degrees to about 25 degrees. In the embodiment shown, the conductor contact wall 682, the wedge support wall 684, the rear wall 686 and the wedge receiving channel 688 form the C-shaped like body or member.

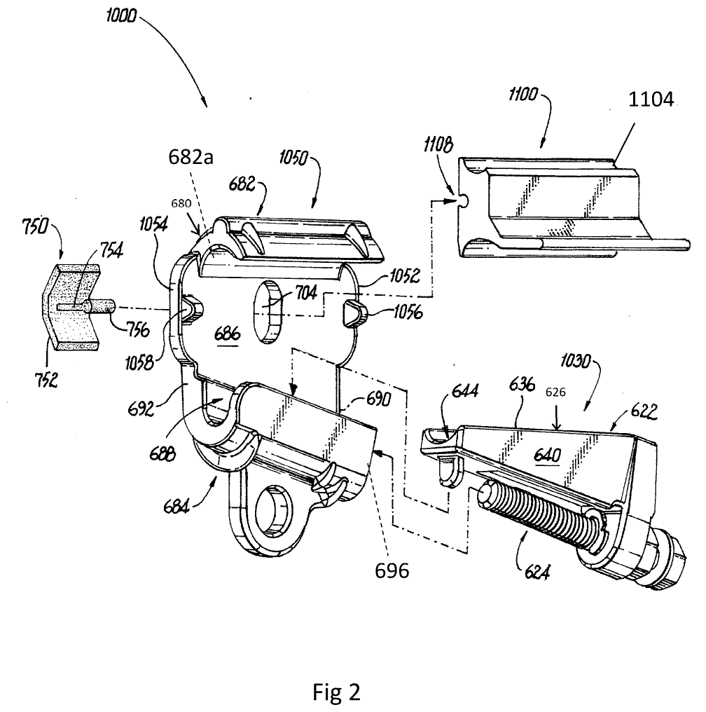

The wedge support wall 684 of the frame 680 includes a mounting member or tab 696 extending from the wedge support wall 684 and/or the rear wall 686. The mounting member 696 is a substantially solid member having an internally threaded bore (not shown) that passes through the mounting member 696. The threaded bore is configured and dimensioned to receive the fastener 624 of the wedge assembly 1030. The first end 690 of the rear wall 686 has an ear 1052 extending therefrom so that the ear 1052 is in the same plane as the rear wall 686. Similarly, the second end 692 of the rear wall 686 has an ear 1054 extending therefrom so that the ear 1054 is in the same plane as the rear wall 686. The ears 1052 and 1054 extend the width of the rear wall 686 of the frame 1050, as shown in FIGS. 2 and 3. The ear 1052 is a substantially flat wall that is integrally or monolithically formed into the rear wall 686 or is secured to the rear wall using, for example, welds, adhesives or fasteners. The ear 1052 includes a stop member 1056, seen in FIGS. 1 and 2, used to prevent longitudinal movement of the interface 1100 along axis “A” when mated with the frame 1050. The stop member 1056 may also limit and possibly prevent rotation of the interface 1100 when tightening the fastener 624 of the wedge assembly 1030 to secure the main conductor 800 and the tap conductor 810 to the frame 1050. Similarly, the ear 1054 is a substantially flat wall that is integrally or monolithically formed into the rear wall 686 or is secured to the rear wall using, for example, welds, adhesives or fasteners. The ear 1054 includes a stop member 1058 used to prevent longitudinal movement of the interface 1100 along axis “A” when mated with the frame 1050. The stop member 1058 may also limit and possibly prevent rotation of the interface 1100 when tightening the fastener 624 of the wedge assembly 1030 to secure the main conductor 800 and the tap conductor 810 to the frame 1050.

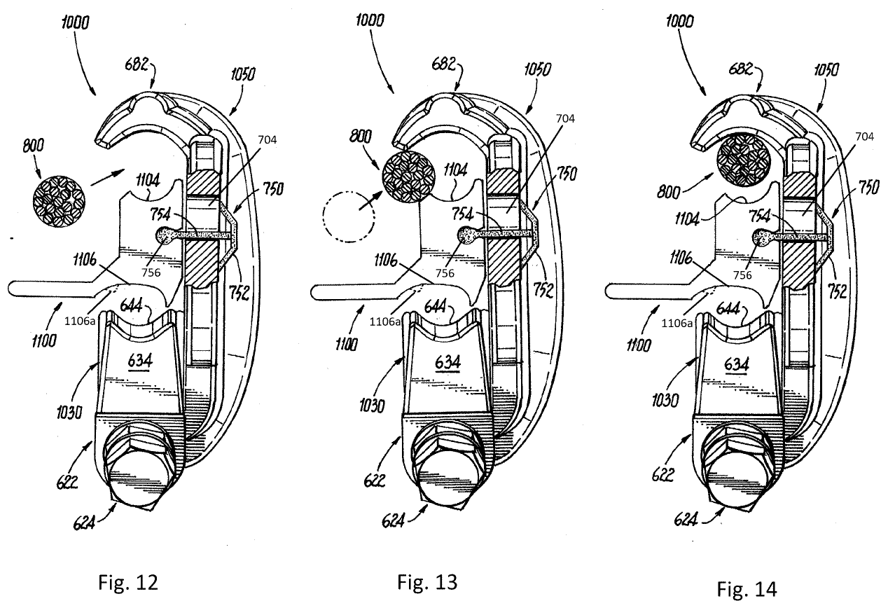

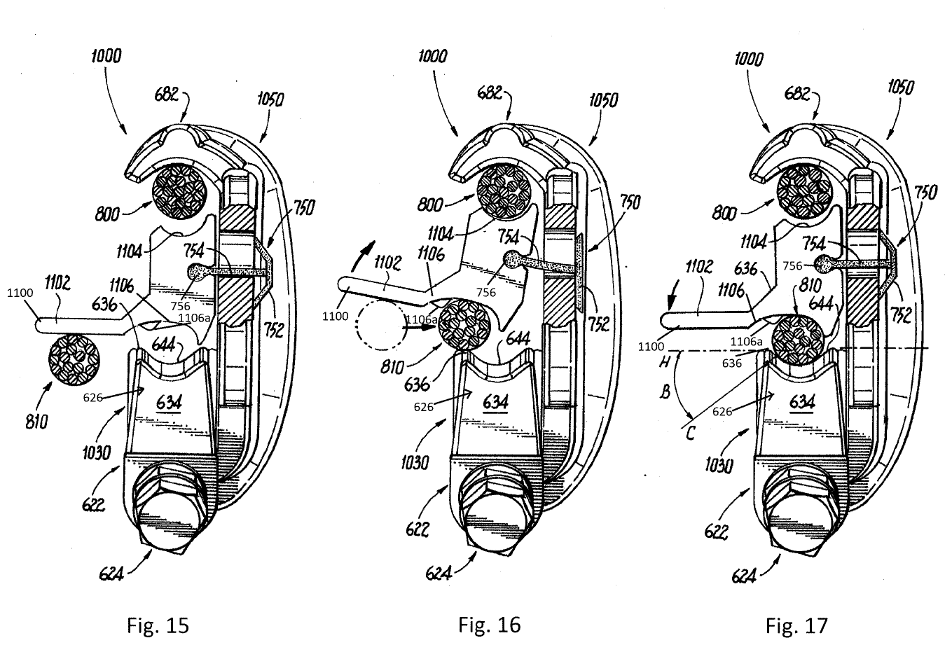

The connector 1000 is first assembled where the interface 1100 is mated to the frame 1050 using the connecting member 750, as shown in FIG. 2, and the wedge 622 is attached to the frame 1050 using the fastener 624 of the wedge assembly 1030. The wedge 622 is attached to the frame 1050 so that wedge 622 is substantially withdrawn from a center of the frame 680, as shown in FIG. 1. At this point, the interface 1100 is in close proximity to the wedge assembly 1030. The connector 1000 is then suspended from a main conductor 800 by placing the inner surface of the conductor contact wall 682 onto the main conductor 800. When placing the inner surface of the conductor contact wall 682 onto the main conductor 800, the interface 1100 may need to move axially and/or linearly, e.g., flex, relative to the frame 1050 so that the interface 1100 is not obstructing the placement of the inner surface onto the main conductor 800. As shown in greater detail in FIGS. 12-17, the interface coupling member 756 and leg 754 of the connecting member 750 allow the interface 1100 to flex and move axially relative to the frame 1050 when installing the main conductor 800 and the tap conductor 810 into the connector 1000. In addition, as noted above, the leg 754 is made of an elastomeric material that allows the leg 754 and thus the interface 1100 to further flex and move axially relative to the frame 1050. More specifically, leg 754 and interface coupling member 756 provide a snap operation when installing a main conductor 800 into the connector 1000. Referring to FIGS. 12-14, to position the main conductor 800 into the connector 1000, the connecting member 750 is initially positioned at the bottom of the opening 704 in the frame 1050, and the main conductor 800 is positioned in close proximity to the frame 1050 and the interface 1100 using for example an extendable reach tool (not shown). The main conductor 800 is then guided toward the conductor contact wall 682 and any force applied by the main conductor 800 onto the interface 1100 causes the interface 1100 to radially flex toward the wedge assembly 1030 extending the leg 754 of the connecting member 750, as seen in FIG. 13. When the main conductor passes into the gap between the conductor contact wall 682 and the contact surface 1104 of the interface 1100, the force flexing the leg 754 is removed causing the interface 1100 to return (e.g., snap back) back to its normal position, seen in FIG. 14, closing the gap between the conductor contact wall 682 and the contact surface 1104 of the interface 1100. To position the tap conductor 810 into the connector 1000, the tap conductor 810 is positioned in close proximity to the frame 1050 and the interface 1100, seen in FIG. 15, using for example an extendable reach tool (not shown). The tap conductor 810 is then guided toward the contact surface 644 of the wedge body 626 of the wedge 622, and any force applied by the tap conductor 810 onto the tab 1102 of the interface 1100 causes the interface 1100 to radially flex toward the conductor contact wall 682 of the frame 1050 extending the leg 754 of the connecting member 750, as seen in FIG. 16. When the tap conductor 810 passes into the gap between the contact surface 644 of the wedge body 626 and the contact surface 1106 of the interface 1100, the force flexing the leg 754 is removed causing the interface 1100 to return (e.g., snap back) back to its normal position, seen in FIG. 17, closing the gap between the contact surface 644 of the wedge body 626 and the contact surface 1106 of the interface 1100. As will be described in detail below with respect to described embodiments, contact surface 1106 may include an optional bump 1106a to help minimize or prevent separation of the strands from the tap conductor 810. Optional bump 1106a also aids in securing tap conductor 810 when being urged or “snapped” into position within connector 1000 as will be appreciated from FIGS. 15-17. In each of the described embodiments, the tab (e.g., tab 1102) may have an aperture (not shown) configured to interact with an extendible reach tool.

With the conductors 800 and 810 positioned in the connector 1000, the fastener 624 is rotated, e.g., tightened, so that wedge 622 moves toward and into the interior of the frame 1050 causing the contact surface 644 of the wedge body 626 to engage the bottom surface of the tap conductor 810. As the wedge 622 is further moved into the interior of the frame 1050, the wedge body 626 pushes the tap conductor 810 into engagement with the contact surface 106 of the interface 1100. Continued movement of the wedge 622 into the interior of the frame 680 causes the interface 1100 to move upwardly within the opening 704 in the frame 1050 causing the contact surface 1104 of the interface 1100 into contact with the main conductor 800. Continued tightening of the fastener 624 forces the main conductor 800 against the inner surface 682a of the conductor contact wall 682 of the frame 680. The fastener 624 is tightened until a stable, electrically conductive path is established between the main conductor 800 and the tap conductor 810. Fastener 624 may be a shear fastener, so that the cap nut 58 shears off when sufficient force has been applied by the wedge 622 against the tap conductor 810, the interface 1100, the main conductor 800 and frame 1050, as described above. As noted above, the stops 1056 and 1058 on the frame 1050, seen in FIGS. 2 and 3, may prevent the interface 1100 from rotating as the interface 1100 slides within the opening 704 in the frame 680 toward the conductor contact wall 682.

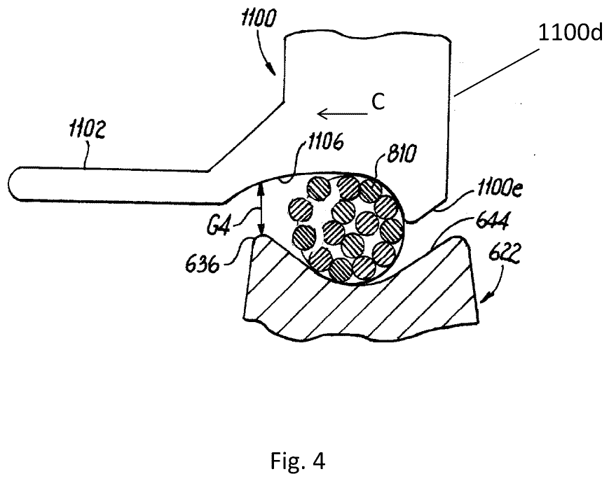

As shown in FIG. 4, a gap “G4” exists between the interface and the wedge. The gap “G4” is such that the interface 1100 does not contact the wedge 622. It will be appreciated that the size or diameter of the conductor may result in a difference in the size of the gap “G4”. A non-limiting exemplary range for larger size tap conductors is between about 350 kcmil and about 636 kcmil. Tap conductors in this range will result in a gap “G4” of a certain size. In instances where an intermediate tap conductor 810 smaller than the larger size tap conductors is connected to the connector 1000, the gap “G4” between the top wall 636 of the wedge body 626 is reduced but the interface 1100 still does not contact the top wall 636 of the wedge body 626. However, there may be instances when connecting an intermediate tap conductor 810 to the connector 1000, where the gap “G4” is reduced such that the bottom portion 1100e of the second side wall 1100d of the interface 1100 may ride along the contact surface 644 of the wedge 622 so that the contact surface 644 does not interfere with the interface 1100. In instances where the gap “G4” is reduced such that the bottom portion 1100e of the second side wall 1100d of the interface 1100 rides along the contact surface 644 of the wedge 622, as the fastener 624 of the wedge 622 is tightened, the portion of the contact surface 1106 nearest bottom portion 1100e may urge or push the tap conductor 810 in the direction “C” so that a larger surface area of the tap conductor 810 contacts the contact surface 1106 of the interface 1100. A non-limiting exemplary range for the intermediate size tap conductors is between about 2/0 AWG and about 266.8 kcmil. In instances where a yet smaller tap conductor 810 is connected to the connector 1000, the gap “G4” between the top wall 636 of the wedge body 626 is reduced but the interface 1100 still does not contact the top wall 636 of the wedge body 626. However, in this instance of connecting a smaller tap conductor 810 to the connector 1000, the gap “G4” is reduced such that the bottom portion 1100e of the second side wall 1100d of the interface 1100 rides along the contact surface 644 of the wedge 622 so that the contact surface 644 does not interfere with the interface 1100. Further, as the bottom portion 1100e of the second side wall 1100d rides along the contact surface 644 of the wedge 622, when the fastener 624 of the wedge 622 is tightened, the portion of the contact surface 1106 closes to bottom portion 1100e may urge or push the tap conductor 810 in the direction “C” so that a larger surface area of the tap conductor 810 contacts the contact surface 1016 of the interface 1100. A non-limiting exemplary range for the smaller size tap conductors is between about 6 AWG and about I/O AWG.

As shown in FIG. 4, as the fastener of the wedge 622 is tightened, strands forming the conductor (in this instance tap conductor 810) may begin to separate or unravel. This may lead to several undesirable results. For example, as the conductor unravels, the diameter or shape of the conductor may change to such a degree that the conductor is no longer firmly held. In extreme situations, the strand or strands of the conductor may continue to unravel until they are no longer contained within the confines of the connector 1000. Conductors in the intermediate to small size may be particularly susceptible to such separation or unraveling.

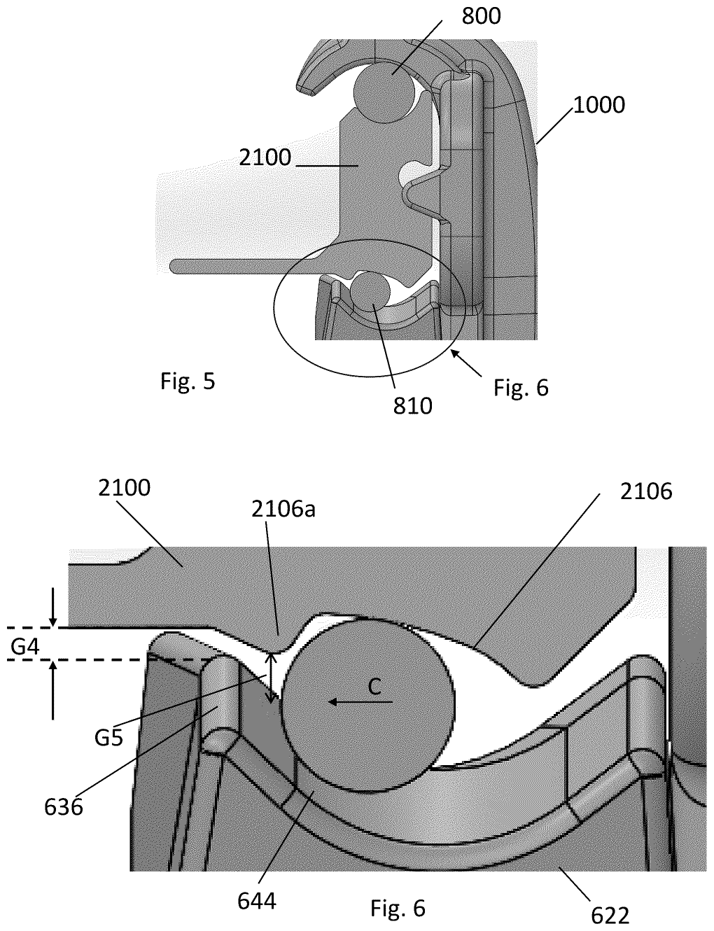

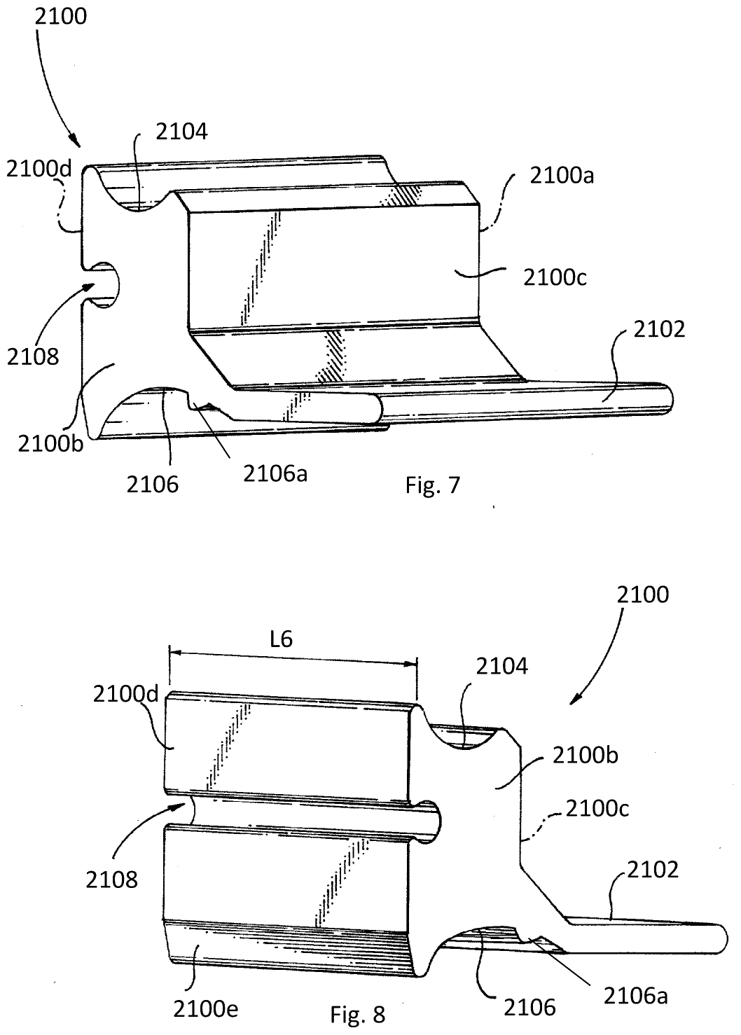

An interface according to an illustrative embodiment of the present disclosure is shown in FIGS. 5-10 and is referred to herein as interface 2100. Interface 2100 is an elongated body having a predefined length “L6” and a width “W5.” In the exemplary embodiment shown, the interface 2100 has a length “L6” that is substantially the same as or smaller than a width of the rear wall 686 of the frame 1050 between stop members 1056 and 1058. In the exemplary embodiment shown, the interface 2100 is a rectangular body having a first end 2100a, a second end 2100b, a first side wall 2100c and a second side wall 2100d. A bottom portion 2100e of the second side wall 2100d may be configured to conform to the contact surface 644 of the wedge 622 so that as the wedge tightens the conductors 800 and 810 directly and/or indirectly to the frame 1050, the contact surface 644 of the wedge 622 does not interfere with the operation of the interface 2100 as will be appreciated from the detailed description below. A tab 2102 may extend from either the first side wall 2100c or the second side wall 2100d of the interface 2100. Preferably, the tab 2102 extends from a lower portion of the first side wall 2100c so that the tab 2102 is substantially perpendicular to the side wall 2100c. It is noted however, that the tab 2102 may be at a non-perpendicular angle relative to the side wall 2100c. Similar to that described above with respect to FIGS. 15-17, the tab 2102 may also act as a lead-in for inserting a tap conductor between the contact surface 644 of the wedge 622 and a contact surface 2106 formed in a lower surface of the interface 2100.

The contact surface 2104 is formed in an upper surface of the interface 2100 and is substantially similar to the contact surfaces on the upper surface 1104 of the interface 1100 described above. The contact surface 2104 is configured and dimensioned to receive or fit at least partially around a main conductor 800. A contact surface 2106 is formed in a lower surface of the interface 2100. The contact surface 2106 may include an optional bump 2106a. The optional bump 2106a extends across at least a portion of the length “L6” of the interface 2100 and preferably across the entire length “L6” of the interface 2100. As depicted in FIG. 4 and as described above, when bump 2106a is not provided, the strands forming conductor 810 may tend to separate when pressure is applied to conductor 810 when being pressed between interface 2104 and wedge 622. As shown in FIGS. 5 and 6, the optional bump 2106a is positioned on contact surface 2106 to help minimize or prevent separation of the strands from tap conductor 810. The contact surface 2106 and bump 2106a are configured and dimensioned to receive or fit at least partially around a tap conductor 810. The contact surface 2106 may also be configured and dimensioned to form a gap “G4” between the contact surface 2106 and the top wall 636 of the wedge 622 and a gap “G5” between the bump 2106a and the contact surface 644 as shown in FIG. 6. The gap “G4” is provided so that at least a portion of the contact surface 2106 does not contact the top wall 636 of the wedge 622 when tightening the wedge 622 to the frame 1050. Bump 2106a is dimensioned and positioned on contact surface 2106 so that the gap “G5” also assures that the bump 2106a does not contact the contact surface 644 of the wedge 622 when tightening the wedge 622 to the frame 1050. The contact surface 2106 may also be configured and dimensioned to urge or push the tap conductor 810, especially smaller size tap conductors, in the direction “C” so that a larger surface area of the tap conductor 810 contacts the contact surface 2106 and urges the tap conductor 810 toward bump 2106a of the interface 2100. As the tap conductor 810 is being pressed between wedge 622 and interface 2100, the bump 2106a will prevent or limit potential separation or unraveling of the strands from the tap conductor 810.

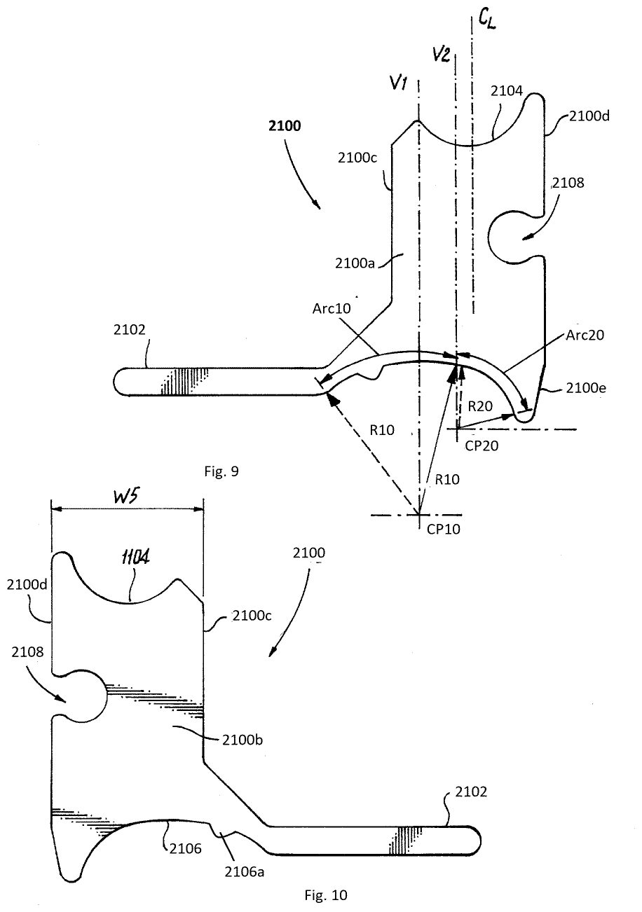

Referring to FIGS. 9 and 10, as a non-limiting example, the shape of the contact surface 2106 can be considered to have one or more and in this instance two concave arcuate surfaces with different radii R10 and R20 and an optional convex arcuate raised bump 2106a. The radius R10 is associated with an Arc 10 and is centered at a center point CP10, as shown in FIG. 9. Bump 2106a is provided on a portion of contact surface 2106 generally associated with Arc 10 and such that it does not interfere with the top wall 636 of wedge 622. The center point CP10 is set so that the radius R10 is sufficient to form the desired gap “G4” between the contact surface 2106 and the top wall 636 of wedge 622 and the desired gap “G5” between the bottom of the bump 2106a and contact surface 644 of the wedge 622. One of the factors that determines the size of the gaps “G4” and “G5” and thus the radius R10 as well as the positioning and dimensions of the raised bump 2106a includes the size or size range of the tap conductors 810 the interface 2100 is designed to connect to. The radius R20 is associated with an Arc 20 and is centered at a center point CP20. The center point CP20 is set so that the radius R20 is sufficient to urge or push the tap conductor 810, especially smaller size tap conductors, in the direction “C” towards bump 2106a so that a larger surface area of the tap conductor 810 contacts the contact surface 2106 and the bump 2106a of the interface 2100. As noted above, bump 2106a limits the amount of deformation of the tap conductor and prevents or minimizes the risk of tap conductor 810 separating or unraveling. In addition, if the tap conductor 810 should begin to unravel, the bump 2106a will limit the amount of unraveling and will help maintain the strands within the confines of the frame 1050. A factor that determines the position of the center point CP20 and thus the size of the radius R20 includes the size or size range of the tap conductor 810 the interface 2100 is designed to connect to. In some embodiments, the center point CP20 may be aligned with a vertical line “V20” that is offset from a center line “C_{L}” of the radius of the contact surface 2104, as shown in FIG. 9. In other embodiments, the center point CP20 may be aligned with the center line “C_{L}” of the radius of the contact surface 2104.

Either the first side wall 2100c or the second side wall 2100d of interface 2100 includes mounting element 2108, e.g., a channel, configured and dimensioned to interact with the connecting members 750. The connecting members 750 are provided to be attached to the interface 2100 and to mate the interface 2100 to the frame 1050 so that the interface 2100 can flex and move when installing the main conductor 800 and the tap conductor 810 into the connector 1000 as described above with respect to FIGS. 15-17. One or more connecting members 750 may be used.

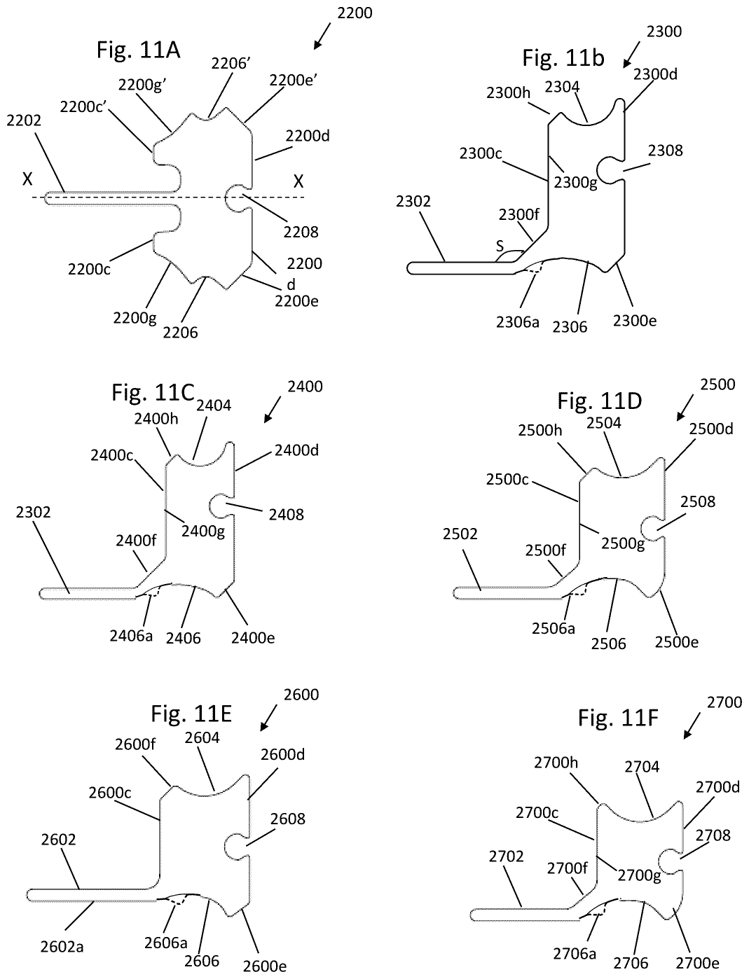

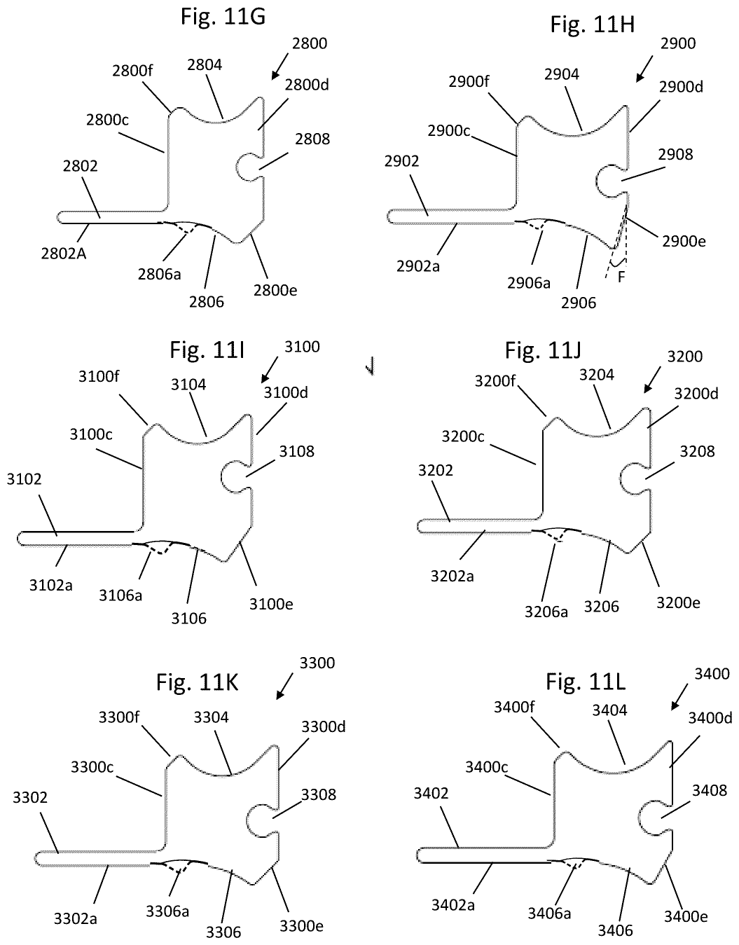

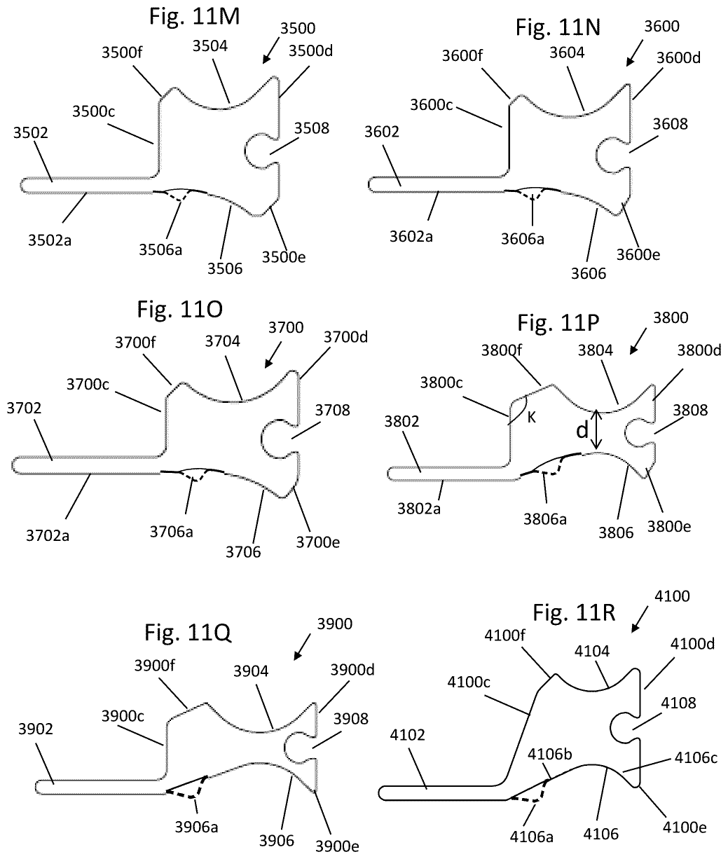

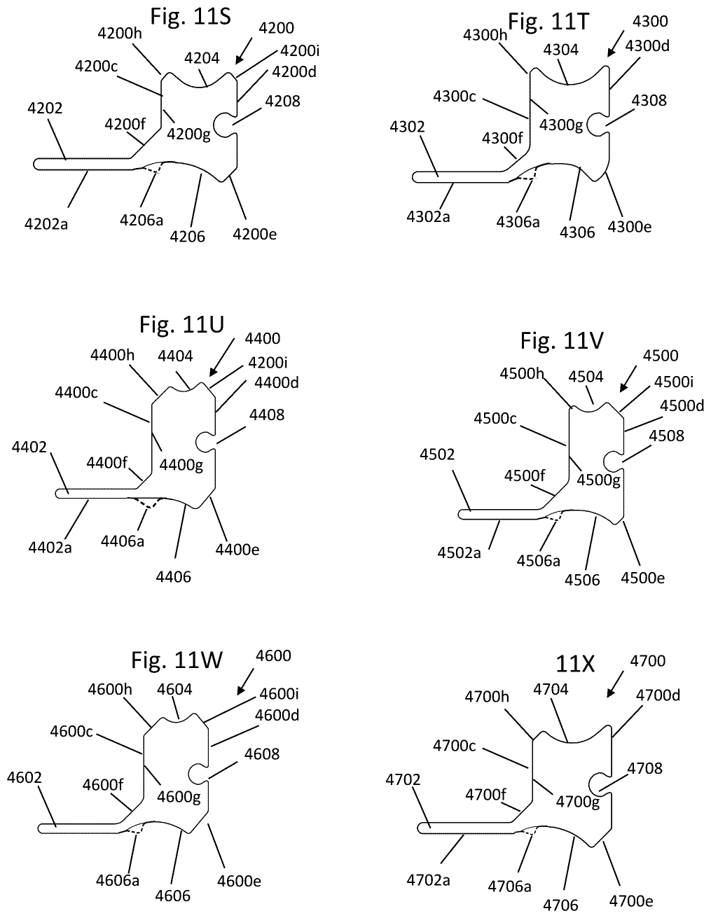

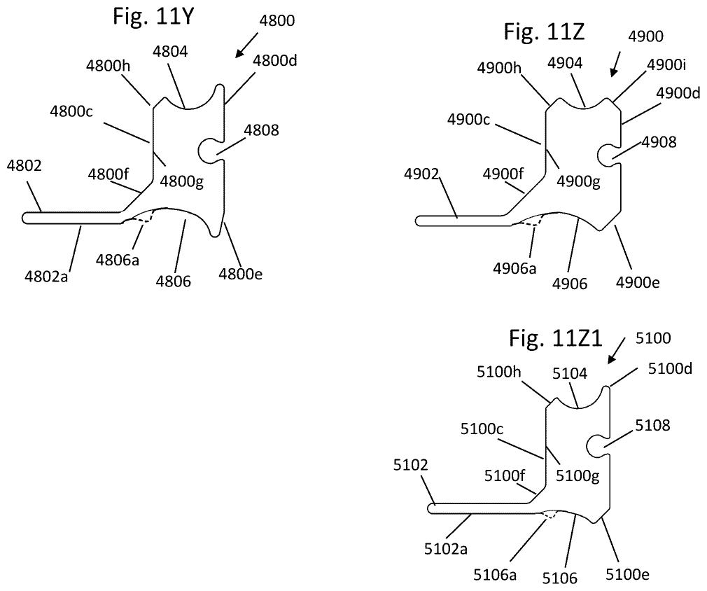

Interfaces according to other illustrative embodiments of the present disclosure are depicted in FIGS. 11A-11Z1. Subtle changes can be made to the configurations and/or dimensions of the interfaces described herein to achieve different and/or improved results in the use of the interfaces. These interfaces may be used to connect conductors including tap conductors in the smaller range or intermediate range or larger range as appropriate. As described above, a non-limiting exemplary range for the smaller size tap conductors is between about 6 AWG and about I/O AWG. While the interfaces depicted in FIGS. 11A-11Z1 are illustrated only in cross-section for reasons of brevity, it will be appreciated that each interface has an elongated body having a predefined length and a width similar to the above-described embodiments. For example, each interface has a length “L6” that is substantially the same as or smaller than a width of the rear wall 686 of the frame 1050 between stop members 1056 and 1058. Each interface is a rectangular body having a first end, a second end, a first side wall and a second side wall, similar to those interfaces as described above.

An interface according to an exemplary embodiment of the present disclosure is depicted in FIG. 11A and is referred to herein as interface 2200. According to this embodiment, interface 2200 is symmetrical about axis X-X and is particularly well suited for connecting conductors such as one or more main conductors and/or one or more tap conductors that are in the smaller size range. Top and bottom portions 2200e′, 2200e of the second side wall 2200d may be configured to conform to the contact surface 682a of frame 1050 and contact surface 644 of the wedge 622, respectively, so that as the wedge tightens the conductors directly and/or indirectly to the frame 1050, the contact surface 682a of frame 1050 and contact surface 644 of the wedge 622 do not interfere with the operation of the interface 2200, as described with respect to above embodiments. A tab 2202 may extend from either the first side wall 2200c or the second side wall 2200d of the interface 2200. Preferably, the tab 2202 extends from the middle portion of the side wall 2200c so that the tab 2202 is substantially perpendicular to the side wall 2200c. It is noted however, that the tab 2202 may be at a non-perpendicular angle relative to the side wall 2200c. Tab 2202 may also act as a lead-in for inserting a tap conductor between the contact surface 644 of the wedge 622 and a contact surface 2206 formed in a lower surface of the interface 2200 as described with respect to earlier embodiments. The tab 2202 may have an aperture (not shown) configured to interact with an extendible reach tool.

The shapes of the contact surfaces 2206, 2206′ can each be considered to have one or more and in this instance two concave arcuate surfaces with different radii R10 and R20 and an optional convex arcuate raised bump 2106a. The radius R10 is associated with an Arc 10 and is centered at a center point CP10, as shown in FIG. 9. The center point CP10 is set so that the radius R10 is sufficient to form the desired gap “G4” between the contact surface 2206 and the top wall 636 of wedge 622. One of the factors that determines the size of the gap “G4” and thus the radius R10 includes the size or size range of the tap conductors 810 the interface 2200 is designed to connect to. The radius R20 is associated with an Arc 20 and is centered at a center point CP20. The center point CP20 is set so that the radius R20 is sufficient to urge or push the tap conductor 810, especially smaller size tap conductors, in the direction “C” so that a larger surface area of the tap conductor 810 contacts the contact surface 2206 of the interface 2200. A factor that determines the position of the center point CP20 and thus the size of the radius R20 includes the size or size range of the tap conductor 810 the interface 2200 is designed to connect to. In some embodiments, the center point CP20 may be aligned with a vertical line “V20” that is offset from a center line “C_{L}” of the radius of the contact surface 2204, as shown in FIG. 9. In other embodiments, the center point CP20 may be aligned with the center line “C_{L}” of the radius of the contact surface 2104.

Either the first side wall 2200c or the second side wall 2200d of interface 2200 includes mounting element 2208, e.g., a channel, configured and dimensioned to interact with the connecting members 750. As described above with respect to earlier embodiments (e.g., see FIG. 6), the connecting members 750 are provided to be attached to the interface 2200 and to mate the interface 2200 to the frame 1050 so that the interface 2200 can flex and move when installing the main conductor 800 and the tap conductor 810 into the interface 2200, as described above with respect to FIGS. 12-17.

An interface according to another exemplary embodiment of the present disclosure is depicted in FIG. 11B and is referred to herein as interface 2300. Interface 2300 has a first side wall 2300c which includes a first side wall portion 2300f which extends from tab 2302 at an angle “S” greater than 90 degrees. The angle “S” may generally between 90 and 135 degrees. First side wall portion 2300f of first side wall 2300c then transitions to upper portion 2300g which is parallel to second side wall 2300d. Upper portion 2300g then extends at an angle to portion 2300h which transitions to contact surface 2304 as shown. A bottom portion 2300e of the second side wall 2300d may be configured to conform to the contact surface 644 of the wedge 622. In this exemplary embodiment, bottom portion 2300e is flat and extends at an angle from second side wall 2300d and is arranged so that as the wedge tightens the conductors directly and/or indirectly to the frame 1050, the contact surface 644 of the wedge 622 does not interfere with the operation of the interface 2300, as shown and described with respect to the above-illustrated embodiments. A tab 2302 may extend from either the first side wall 2300c or the second side wall 2300d of the interface 2300. Preferably, the tab 2302 extends from a lower portion of the side wall 2300c so that the tab 2302 is substantially perpendicular to at least a portion of the side wall 2300c. It is noted however, that the tab 2302 may be at a non-perpendicular angle relative to the side wall 2300c. Tab 2302 may also act as a lead-in for inserting a tap conductor between the contact surface 644 of the wedge 622 and the contact surface 2306 formed in a lower surface of the interface 2300 as described with respect to earlier embodiments. The tab 2302 may have an aperture (not shown) configured to interact with an extendible reach tool.

A contact surface 2304 is formed in an upper surface of the interface 2300 and is substantially similar to the contact surfaces on the upper surface of the other interfaces described herein. The contact surface 2304 is configured and dimensioned to receive or fit at least partially around a main conductor 800. The contact surface 2306 is formed in a lower surface of the interface 2300. The contact surface 2306 may include a bump 2306a which extends across at least a portion of the length “L6” of the interface 2300 and preferably across the entire length “L6” of the interface 2300. The contact surface 2306 is configured and dimensioned to receive or fit at least partially around a tap conductor 810. As described above with respect to earlier embodiments, the contact surface 2306 may also be configured and dimensioned to form a gap “G4” between the contact surface 2306 and the top wall 636 of the wedge 622 and a gap “G5” between the bump 2306a and the contact surface 644 as shown and described above with respect to FIG. 6. The gap “G4” is provided so that at least a portion of the contact surface 2306 does not contact the top wall 636 of the wedge 622 when tightening the wedge 622 to the frame 1050. Bump 2306a is dimensioned and positioned on contact surface 2306 so that the gap “G5” also assures that the bump 2306a does not contact the contact surface 644 of the wedge 622 when tightening the wedge 622 to the frame 1050. The contact surface 2306 may also be configured and dimensioned to urge or push the tap conductor 810, especially smaller size tap conductors, in a direction “C” so that a larger surface area of the tap conductor 810 contacts the contact surface 2306 and urges the tap conductor 810 toward bump 2306a of the interface 2300, similar to that shown and described above with respect to FIGS. 4-6. As the tap conductor 810 is being pressed between contact surface 644 of wedge 622 and contact surface 2306, the tap conductor 810 is urged toward and into contact with bump 2306a which will prevent or limit potential unraveling of the strands of the tap conductor 810. As a non-limiting example, the shape of the contact surface 2306 can be considered to have two concave arcuate surfaces with different radii similar to that described above with respect to FIG. 9 and an optional convex arcuate raised bump 2306a similar to that described above. As depicted in various embodiments to be described herein, the differences in radii of the two concave arcuate surfaces may be substantially the same or may be different. The convex arcuate raised bump 2306a protrudes from a portion of the contact surface 2306 generally associated with Arc 10. In any of the described embodiments, the radii and their center points may be set sufficient to form the desired gap “G4” between the contact surface 2306 and the top wall 636 of the wedge 622. A factor that determines the size of the gap “G4” and thus the radii as well as the positioning and dimensions of the raised bump 2306a includes the size or size range of the tap conductors 810 the interface 2300 is designed to connect to.

Either the first side wall 2300c or the second side wall 2300d of interface 2300 includes mounting element 2308, e.g., a channel, configured and dimensioned to interact with the connecting members 750. As described above with respect to earlier embodiments, the connecting members 750 are provided to be attached to the interface 2300 and to mate the interface 2300 to the frame 1050 so that the interface 2300 can flex and move when installing the main conductor 800 and the tap conductor 810 into the connector 1000, as described above with respect to FIGS. 12-17.

An interface according to another illustrative embodiment of the present disclosure is depicted in FIG. 11C and is referred to herein as interface 2400. Interface 2400 has a first side wall 2400c which includes a first side wall portion 2400f which extends from tab 2402 at an angle “S” greater than 90 degrees similar to that described above with respect to FIG. 11B. The angle “S” may generally between 90 and 135 degrees. First side wall portion 2400f of first side wall 2400c then transitions to upper portion 2400g which is parallel to second side wall 2400d. Upper portion 2400g then extends at an angle to portion 2400h which transitions to contact surface 2404 as shown. Bottom portion 2400e of second side wall 2400d may be configured to conform to the contact surface 644 of the wedge 622. In this exemplary embodiment, bottom portion 2400e is flat and extends at an angle from second side wall 2400d and is arranged so that as the wedge tightens the conductors 800 and 810 directly and/or indirectly to the frame 1050, the contact surface 644 of the wedge 622 does not interfere with the operation of the interface 2400, as shown in the above-described embodiments. Tab 2402 may extend from either the first side wall 2400c or the second side wall 2400d of the interface 2400. Preferably, the tab 2402 extends from a lower portion of the side wall 2400c so that the tab 2402 is substantially perpendicular to at least a portion of side wall 2400c. It is noted however, that the tab 2402 may be at a non-perpendicular angle relative to the side wall 2400c. Tab 2402 may also act as a lead-in for inserting a tap conductor between the contact surface 644 of the wedge 622 and a contact surface 2406 formed in a lower surface of the interface 2400. More specifically, when a force is applied by the tap conductor 810 to tab 2402, the tab acting as a lead-in radially flexes toward the conductor contact wall 682 of the frame 1050 extending the leg 754 of the connecting member 750. The tab 2402 may have an aperture (not shown) configured to interact with an extendible reach tool.

A contact surface 2404 is configured and dimensioned to receive or fit at least partially around a main conductor 800. The contact surface 2406 is formed in a lower surface of the interface 2400. The contact surface 2406 may include an optional bump 2406a which extends across at least a portion of the length “L6” of the interface 2400 and preferably across the entire length “L6” of the interface 2400. The contact surface 2406 including bump 2406a is configured and dimensioned to receive or fit at least partially around a tap conductor 810. As described above with respect to earlier embodiments, the contact surface 2406 may also be configured and dimensioned to form a gap “G4” between the contact surface 2406 and the top wall 636 of the wedge 622 and a gap “G5” between the optional bump 2406a and the contact surface 644 as shown and described above with respect to FIG. 6. The gap “G4” is provided so that at least a portion of the contact surface 2406 does not contact the top wall 636 of the wedge 622 when tightening the wedge 622 to the frame 1050. Optional bump 2406a is dimensioned and positioned on contact surface 2406 so that the gap “G5” also assures that the bump 2406a does not contact the contact surface 644 of the wedge 622 when tightening the wedge 622 to the frame 1050. The contact surface 2406 may also be configured and dimensioned to urge or push the tap conductor 810, especially smaller size tap conductors, in a direction “C” so that a larger surface area of the tap conductor 810 contacts the contact surface 2406 and urges the tap conductor 810 toward bump 2406a of the interface 2400, similar to that shown and described above with respect to FIGS. 4-6. As the tap conductor 810 is being pressed, the optional bump 2406a will prevent or limit potential unraveling of the strands from the tap conductor 810. As a non-limiting example, the shape of the contact surface 2406 can be considered to have two concave arcuate surfaces with different radii and a convex arcuate raised bump 2406a similar to that described above with respect to FIG. 9. The convex arcuate raised bump 2406a protrudes from a portion of the contact surface 2406 generally associated with Arc 10. As depicted in various embodiments to be described herein the differences in radii of the two concave arcuate surfaces may be substantially the same or may be different. For example, according to the present embodiment, the radii of the two concave arcuate surfaces are substantially similar or the same. In any of the described embodiments, the radii and the center points of the two concave arcuate surfaces may be set sufficient to form the desired gap “G4” between the contact surface 2406 and the top wall 636 of the wedge 622. A factor that determines the size of the gap “G4” and thus the radii as well as the positioning and dimensions of the optional raised bump 2406a includes the size or size range of the tap conductors 810 the interface 2400 is designed to connect to.

Either the first side wall 2400c or the second side wall 2400d of interface 2400 includes mounting element 2408, e.g., a channel, configured and dimensioned to interact with the connecting members 750. As described above with respect to earlier embodiments, the connecting members 750 are provided to be attached to the interface 2200 and to mate the interface 2400 to the frame 1050 so that the interface 2400 can flex and move when installing the main conductor 800 and the tap conductor 810 into the connector 1000, as described above with respect to FIGS. 12-17.

An interface according to another illustrative embodiment of the present disclosure is shown in FIG. 11D and is referred to herein as interface 2500. Interface 2500 has a first side wall 2500c which includes a first side wall portion 2500f which extends from tab 2502 at an angle “S” greater than 90 degrees similar to that described above with respect to FIG. 11B. The angle “S” may generally between 90 and 135 degrees. First side wall portion 2500f of first side wall 2500c then transitions to upper portion 2500g which is parallel to second side wall 2500d. Upper portion 2500g then extends at an angle to portion 2500h which transitions to contact surface 2504 as shown. According to the present illustrative embodiment, bottom portion 2500e of side wall 2500d has a convex arcuate shape, extends at an angle from second side wall 2500d and may be configured to conform to the contact surface 644 of the wedge. The convex arcuate shape of bottom portion 2500e may allow it to even more easily move along contact surface 644 as the wedge tightens the conductors 800 and 810 directly and/or indirectly to the frame 1050 so that the contact surface 644 of the wedge 622 does not interfere with the operation of the interface 2500 as shown and described above with respect to earlier embodiments. Tab 2502 may extend from either the first side wall 2500c or the second side wall 2500d of the interface 2500. Preferably, the tab 2502 extends from a lower portion of the side wall 2500c so that the tab 2502 is substantially perpendicular to at least a portion of the side wall 2500c. It is noted however, that the tab 2502 may be at a non-perpendicular angle relative to the side wall 2500c. Tab 2502 may also act as a lead-in for inserting a tap conductor between the contact surface 644 of the wedge 622 and a contact surface 2506 formed in a lower surface of the interface 2500 as described with regard to earlier embodiments. The tab 2502 may have an aperture (not shown) configured to interact with an extendible reach tool.

A contact surface 2504 is configured and dimensioned to receive or fit at least partially around a main conductor 800. The contact surface 2506 is formed in a lower surface of the interface 2500. The contact surface 2506 may include an optional bump 2506a which extends across at least a portion of the length “L6” of the interface 2500 and preferably across the entire length “L6” of the interface 2500. The contact surface 2506 including optional bump 2506a is configured and dimensioned to receive or fit at least partially around a tap conductor 810. As described above with respect to earlier embodiments, the contact surface 2506 may also be configured and dimensioned to form a gap “G4” between the contact surface 2506 and the top wall 636 of the wedge 622 and a gap “G5” between the optional bump 2506a and the contact surface 644 as shown and described above with respect to FIG. 6. The gap “G4” is provided so that at least a portion of the contact surface 2506 does not contact the top wall 636 of the wedge 622 when tightening the wedge 622 to the frame 1050. Optional bump 2506a is dimensioned and positioned on contact surface 2506 so that the gap “G5” also assures that the bump 2506a does not contact the contact surface 644 of the wedge 622 when tightening the wedge 622 to the frame 1050. The contact surface 2506 may also be configured and dimensioned to urge or push the tap conductor 810, especially smaller size tap conductors, in a direction “C” so that a larger surface area of the tap conductor 810 contacts the contact surface 2506 and urges the tap conductor 810 toward bump 2506a of the interface 2500, similar to that shown and described above with respect to FIGS. 4-6. As the tap conductor 810 is being compressed, the bump 2506a will prevent or limit potential unraveling of the strands from the tap conductor 810. As a non-limiting example, the shape of the contact surface 2506 can be considered to have two concave arcuate surfaces with different radii and an optional convex arcuate raised bump 2506a similar to that described above with respect to FIG. 9. The convex arcuate raised bump 2506a protrudes from a portion of the contact surface 2506 generally associated with Arc 10. As depicted in various embodiments to be described herein the differences in radii of the two concave arcuate surfaces may be substantially the same or may be different. In any of the described embodiments, the radii and their center points may be set sufficient to form the desired gap “G4” between the contact surface 2506 and the top wall 636 of the wedge 622. A factor that determines the size of the gap “G4” and thus the radii as well as the positioning and dimensions of the raised bump 2506a includes the size or size range of the tap conductors 810 the interface 2500 is designed to connect to.

Either the first side wall 2500c or the second side wall 2500d of interface 2500 includes mounting element 2508, e.g., a channel, configured and dimensioned to interact with the connecting members 750. As described above with respect to earlier embodiments (e.g., see FIG. 2), the connecting members 750 are provided to be attached to the interface 2500 and to mate the interface 2500 to the frame 1050 so that the interface 2500 can flex and move when installing the main conductor 800 and the tap conductor 810 into the connector 1000, as described above with respect to FIGS. 12-17.

An interface according to another illustrative embodiment of the present disclosure is shown in FIG. 11E and is referred to herein as interface 2600. A bottom portion 2600e of the second side wall 2600d is substantially flat and extends at an angle from second side wall 2600d. According to this embodiment, the bottom portion 2600e of the second side wall 2600d extends below an imaginary line extending from a lower side 2602a of tab 2602 (or from a longitudinal edge of a first concave surface forming a portion of contact surface 2606). Bottom portion 2600e may be configured to conform to the contact surface 644 of the wedge and is arranged so that as the wedge tightens the conductors 800 and 810 directly and/or indirectly to the frame 1050, the contact surface 644 of the wedge 622 does not interfere with the operation of the interface 2600, as shown and described above with respect to earlier embodiments. A tab 2602 may extend from either the first side wall 2600c or the second side wall 2600d of the interface 2600. Preferably, the tab 2602 extends from a lower portion of the side wall 2600c so that the tab 2602 is substantially perpendicular to at least a portion of the side wall 2600c. It is noted however, that the tab 2602 may be at a non-perpendicular angle relative to the side wall 2600c. Tab 2602 may also act as a lead-in for inserting a tap conductor between the contact surface 644 of the wedge 622 and a contact surface 2606 formed in a lower surface of the interface 2600. More specifically, when a force applied by the tap conductor 810 to tab 2602, the tab acting as a lead-in radially flexes toward the conductor contact wall 682 of the frame 1050 extending the leg 754 of the connecting member 750. The tab 2602 may have an aperture (not shown) configured to interact with an extendible reach tool.

The contact surface 2604 is configured and dimensioned to receive or fit at least partially around a main conductor 800. The contact surface 2606 is formed in a lower surface of the interface 2600. The contact surface 2606 includes an optional bump 2606a which extends across at least a portion of the length “L6” of the interface 2600 and preferably across the entire length “L6” of the interface 2600. The contact surface 2606 is configured and dimensioned to receive or fit at least partially around a tap conductor 810. As described above with respect to earlier embodiments, the contact surface 2606 may also be configured and dimensioned to form a gap “G4” between the contact surface 2606 and the top wall 636 of the wedge 622 and a gap “G5” between the bump 2606a and the contact surface 644 as shown and described above with respect to FIG. 6. The gap “G4” is provided so that at least a portion of the contact surface 2606 does not contact the top wall 636 of the wedge 622 when tightening the wedge 622 to the frame 1050. Optional bump 2606a is dimensioned and positioned on contact surface 2606 so that the gap “G5” also assures that the bump 2606a does not contact the contact surface 644 of the wedge 622 when tightening the wedge 622 to the frame 1050. The contact surface 2606 may also be configured and dimensioned to urge or push the tap conductor 810, especially smaller size tap conductors, in a direction “C” so that a larger surface area of the tap conductor 810 contacts the contact surface 2606 and urges the tap conductor 810 toward bump 2606a of the interface 2600, similar to that shown and described above with respect to FIGS. 4-6. As the tap conductor 810 is being pressed between the contact surface 2606 and the contact surface 644 of the wedge 622, the bump 2606a will prevent or limit potential unraveling of the strands from the tap conductor 810. As a non-limiting example, the shape of the contact surface 2606 can be considered to have two concave arcuate surfaces with different radii and a convex arcuate raised bump 2606a similar to that described above with respect to FIG. 9. The convex arcuate raised bump 2606a protrudes from a portion of the contact surface 2606 generally associated with Arc 10. As depicted in various embodiments described herein the differences in radii of the two concave arcuate surfaces may be substantially the same or may be different. In any of the described embodiments, the radii and their center points may be set sufficient to form the desired gap “G4” between the contact surface 2606 and the top wall 636 of the wedge 622. A factor that determines the size of the gap “G4” and thus the radii as well as the positioning and dimensions of the raised bump 2606a includes the size or size range of the tap conductors 810 the interface 2600 is designed to connect to.

Either the first side wall 2600c or the second side wall 2600d of interface 2600 includes mounting element 2608, e.g., a channel, configured and dimensioned to interact with the connecting members 750. As described above with respect to earlier embodiments (e.g., see FIG. 2), the connecting members 750 are provided to be attached to the interface 2600 and to mate the interface 2600 to the frame 1050 so that the interface 2600 can flex and move when installing the main conductor 800 and the tap conductor 810 into the connector 1000, as described above with respect to FIGS. 12-17.

An interface according to another illustrative embodiment of the present disclosure is shown in FIG. 11F and is referred to herein as interface 2700. Interface 2700 has a first side wall 2700c which includes a first side wall portion 2700f which extends from tab 2702 at an angle “S” greater than 90 degrees similar to that shown in FIG. 11B. The angle “S” may generally between 90 and 135 degrees. First side wall portion 2700f of first side wall 2700c then transitions to upper portion 2700g which is parallel to second side wall 2700d. Upper portion 2700g then extends at an angle to portion 2700h which transitions to contact surface 2704 as shown. According to the present illustrative embodiment, bottom portion 2700e of second side wall 2700d has a convex arcuate shape and extends at an angle from second side wall 2700d. According to this embodiment, bottom portion 2700e may be configured to conform to the contact surface 644 of the wedge 622 so that as the wedge tightens the conductor directly and/or indirectly to the frame 1050, the contact surface 644 of the wedge 622 does not interfere with the operation of the interface 2700, as shown in the above-described embodiments. Tab 2702 may extend from either the first side wall 2700c or the second side wall 2700d of the interface 2700. Preferably, the tab 2702 extends from a lower portion of the side wall 2700c so that the tab 2702 is substantially perpendicular to at least a portion of the first side wall 2700c. It is noted however, that the tab 2702 may be at a non-perpendicular angle relative to the side wall 2700c. Tab 2702 may also act as a lead-in for inserting a tap conductor between the contact surface 644 of the wedge 622 and a contact surface 2706 formed in a lower surface of the interface 2700. More specifically, when a force applied by the tap conductor 810 to tab 2502, the tab acting as a lead-in radially flexes toward the conductor contact wall 682 of the frame 1050 extending the leg 754 of the connecting member 750. The tab 2702 may have an aperture (not shown) configured to interact with an extendible reach tool.

The contact surface 2704 is configured and dimensioned to receive or fit at least partially around a main conductor 800. The shape and configuration of the contact surface 2704 and the areas where contact surface 2704 joins side walls 2700c and 2700d may also vary as shown in FIG. 11F. For example, the area 2700h where first side wall 2700c transitions to contact surface 2704 is a rounded point as shown and does not include a flat portion similar to above-described embodiments. A contact surface 2706 is formed in a lower surface of the interface 2700. The contact surface 2706 may include an optional bump 2706a which extends across at least a portion of the length “L6” of the interface 2700 and preferably across the entire length “L6” of the interface 2700. The contact surface 2706 is configured and dimensioned to receive or fit at least partially around a tap conductor 810. As described above with respect to earlier embodiments, the contact surface 2706 may also be configured and dimensioned to form a gap “G4” between the contact surface 2706 and the top wall 636 of the wedge 622 and a gap “G5” between the optional bump 2706a and the contact surface 644 as shown and described above with respect to FIG. 6. The gap “G4” is provided so that at least a portion of the contact surface 2706 does not contact the top wall 636 of the wedge 622 when tightening the wedge 622 to the frame 1050. Optional bump 2706a is dimensioned and positioned on contact surface 2706 so that the gap “G5” also assures that the bump 2706a does not contact the contact surface 644 of the wedge 622 when tightening the wedge 622 to the frame 1050. The contact surface 2706 may also be configured and dimensioned to urge or push the tap conductor 810, especially smaller size tap conductors, in a direction “C” so that a larger surface area of the tap conductor 810 contacts the contact surface 2706 and urges the tap conductor 810 toward bump 2706a of the interface 2700, similar to that shown and described above with respect to FIGS. 4-6. As the tap conductor 810 is being pressed between the contact surface 2706 and the contact surface 644 of the wedge 622, the bump 2706a will prevent or limit potential unraveling of the strands from the tap conductor 810. As a non-limiting example, the shape of the contact surface 2706 can be considered to have two concave arcuate surfaces with different radii and an optional convex arcuate raised bump 2706a similar to that described above with respect to FIG. 9. As depicted in various embodiments described herein the differences in radii of the two concave arcuate surfaces may be substantially the same or may be different. The convex arcuate raised bump 2706a protrudes from a portion of the contact surface 2706 generally associated with Arc 10. For example, according to the present embodiment, the radii of the two concave arcuate surfaces are substantially different. In any of the described embodiments, the radii and their center points may be set sufficient to form the desired gap “G4” between the contact surface 2706 and the top wall 636 of the wedge 622. A factor that determines the size of the gap “G4” and thus the radii as well as the positioning and dimensions of the raised bump 2706a includes the size or size range of the tap conductors 810 the interface 2700 is designed to connect to.

Either the first side wall 2700c or the second side wall 2700d of interface 2700 includes mounting element 2708, e.g., a channel, configured and dimensioned to interact with the connecting members 750. The connecting members 750 are provided to be attached to the interface 2700 and to mate the interface 2700 to the frame 1050 so that the interface 2700 can flex and move when installing the main conductor 800 and the tap conductor 810 into the connector 1000, as described above with respect to FIGS. 12-17.

An interface according to another illustrative embodiment of the present disclosure is shown in FIG. 11G and is referred to herein as interface 2800. According to the present illustrative embodiment, bottom portion 2800e may be configured to conform to the contact surface 644 of the wedge 622. In this exemplary embodiment, bottom portion 2800e of the second side wall 2800d is flat and extends at an angle from second side wall 2800d. According to this embodiment, the bottom portion 2800e of the second side wall 2800d extends below an imaginary line extending from a lower side 2802a of tab 2802. Bottom portion 2800e may be configured to conform to the contact surface 644 of the wedge and is arranged so that as the wedge tightens the conductor directly and/or indirectly to the frame 1050, the contact surface 644 of the wedge 622 does not interfere with the operation of the interface 2800, as shown and described above with respect to earlier embodiments. A tab 2802 may extend from either the first side wall 2800c or the second side wall 2800d of the interface 2800. Preferably, the tab 2802 extends from a lower portion of the side wall 2800c so that the tab 2802 is substantially perpendicular to at least a portion of the side wall 2800c. It is noted however, that the tab 2802 may be at a non-perpendicular angle relative to the side wall 2800c. Tab 2802 may also act as a lead-in for inserting a tap conductor between the contact surface 644 of the wedge 622 and a contact surface 2806 formed in a lower surface of the interface 2800. More specifically, when a force applied by the tap conductor 810 to tab 2802, the tab acting as a lead-in radially flexes toward the conductor contact wall 682 of the frame 1050 extending the leg 754 of the connecting member 750. The tab 2802 may have an aperture (not shown) configured to interact with an extendible reach tool.

The contact surface 2804 is configured and dimensioned to receive or fit at least partially around a main conductor 800. As discussed above, the shape and configuration of the contact surface 2804 and the areas where contact surface 2804 joins side walls 2800c and 2800d may vary. For example, according to the present embodiment, the portion 2800f where first side wall 2800c meets contact surface 2804 is a rounded point similar to but having a larger radius than the rounded point 2700f shown in FIG. 11F. The contact surface 2806 is formed in a lower surface of the interface 2800. The contact surface 2806 may include an optional bump 2806a which extends across at least a portion of the length “L6” of the interface 2800 and preferably across the entire length “L6” of the interface 2800. The contact surface 2806 including optional bump 2806a is configured and dimensioned to receive or fit at least partially around a tap conductor 810. As described above with respect to earlier embodiments, the contact surface 2806 may also be configured and dimensioned to form a gap “G4” between the contact surface 2806 and the top wall 636 of the wedge 622 and a gap “G5” between the optional bump 2806a and the contact surface 644 as shown and described above with respect to FIG. 6. The gap “G4” is provided so that at least a portion of the contact surface 2806 does not contact the top wall 636 of the wedge 622 when tightening the wedge 622 to the frame 1050. Optional bump 2806a is dimensioned and positioned on contact surface 2806 so that the gap “G5” also assures that the bump 2806a does not contact the contact surface 644 of the wedge 622 when tightening the wedge 622 to the frame 1050. The contact surface 2806 may also be configured and dimensioned to urge or push the tap conductor 810, especially smaller size tap conductors, in a direction “C” so that a larger surface area of the tap conductor 810 contacts the contact surface 2806 and urges the tap conductor 810 toward bump 2806a of the interface 2800, similar to that shown and described above with respect to FIGS. 4-6. As the tap conductor 810 is being pressed between the contact surface 2806 and the contact surface 644 of the wedge 622, the bump 2806a will prevent or limit potential unraveling of the strands from the tap conductor 810. As a non-limiting example, the shape of the contact surface 2806 can be considered to have two concave arcuate surfaces with different radii and an optional convex arcuate raised bump 2806a similar to that described above. As depicted in various embodiments described herein the differences in radii of the two concave arcuate surfaces may be substantially the same or may be different. The convex arcuate raised bump 2806a protrudes from a portion of the contact surface 2806 generally associated with Arc 10 (FIG. 9). In any of the described embodiments, the radii and their center points may be set sufficient to form the desired gap “G4” between the contact surface 2806 and the top wall 636 of the wedge 622 and to urge the conductor in direction “C” as described above. A factor that determines the size of the gap “G4” and thus the radii as well as the positioning and dimensions of the raised bump 2806a includes the size or size range of the tap conductors 810 the interface 2800 is designed to connect to.

Either the first side wall 2800c or the second side wall 2800d of interface 2800 includes mounting element 2808, e.g., a channel, configured and dimensioned to interact with the connecting members 750. As described above with respect to earlier embodiments (e.g., see FIG. 2), the connecting members 750 are provided to be attached to the interface 2800 and to mate the interface 2800 to the frame 1050 so that the interface 2800 can flex and move when installing the main conductor 800 and the tap conductor 810 into the connector 1000, as described above with respect to FIGS. 12-17.

An interface according to another illustrative embodiment of the present disclosure is shown in FIG. 11H and is referred to herein as interface 2900. In addition to having different possible shapes (e.g., flat, convex, etc.) the bottom portion 2900e of the second side wall 2900d may extend at various angles from second side wall 2900d. For example, as depicted in FIG. 11H, bottom portion 2900e is flat and extends from second side wall 2900d at an angle “F” which is generally a shallower angle than other embodiments (e.g., see FIG. 11G). Angle “F” may vary generally between zero degrees and 45 degrees. According to this embodiment, the bottom portion 2900e of the second side wall 2900d extends below an imaginary line extending from a lower side 2902a of tab 2902. Bottom portion 2900e may be configured to conform to the contact surface 644 of the wedge and is arranged so that as the wedge tightens the conductor directly and/or indirectly to the frame 1050, the contact surface 644 of the wedge 622 does not interfere with the operation of the interface 2900, as shown and described above with respect to earlier embodiments. A tab 2902 may extend from either the first side wall 2900c or the second side wall 2900d of the interface 2900. Preferably, the tab 2902 extends from a lower portion of the side wall 2900c so that the tab 2902 is substantially perpendicular to at least a portion of the side wall 2900c. It is noted however, that the tab 2902 may be at a non-perpendicular angle relative to the side wall 2900c. Tab 2902 may also act as a lead-in for inserting a tap conductor between the contact surface 644 of the wedge 622 and a contact surface 2906 formed in a lower surface of the interface 2900. More specifically, when a force applied by the tap conductor 810 to tab 2902, the tab acting as a lead-in radially flexes toward the conductor contact wall 682 of the frame 1050 extending the leg 754 of the connecting member 750. The tab 2902 may have an aperture (not shown) configured to interact with an extendible reach tool.

The contact surface 2904 is configured and dimensioned to receive or fit at least partially around a main conductor 800. The contact surface 2906 is formed in a lower surface of the interface 2900. The contact surface 2906 may include an optional bump 2906a which extends across at least a portion of the length “L6” of the interface 2900 and preferably across the entire length “L6” of the interface 2900. The contact surface 2906 is configured and dimensioned to receive or fit at least partially around a tap conductor 810. As described above with respect to earlier embodiments, the contact surface 2906 may also be configured and dimensioned to form a gap “G4” between the contact surface 2906 and the top wall 636 of the wedge 622 and a gap “G5” between the optional bump 2906a and the contact surface 644 as shown and described above with respect to FIG. 6. The gap “G4” is provided so that at least a portion of the contact surface 2906 does not contact the top wall 636 of the wedge 622 when tightening the wedge 622 to the frame 1050. Optional bump 2906a is dimensioned and positioned on contact surface 2906 so that the gap “G5” also assures that the bump 2906a does not contact the contact surface 644 of the wedge 622 when tightening the wedge 622 to the frame 1050. The contact surface 2906 may also be configured and dimensioned to urge or push the tap conductor 810, especially smaller size tap conductors, in a direction “C” so that a larger surface area of the tap conductor 810 contacts the contact surface 2906 and urges the tap conductor 810 toward bump 2906a of the interface 2900, similar to that shown and described above with respect to FIGS. 4-6. As the tap conductor 810 is being pressed between the contact surface 2906 and the contact surface 644 of the wedge 622, the bump 2906a will prevent or limit potential unraveling of the strands from the tap conductor 810. As a non-limiting example, the shape of the contact surface 2906 can be considered to have two concave arcuate surfaces with different radii and an optional convex arcuate raised bump 2906a similar to that described above. As depicted in various embodiments described herein the differences in radii of the two concave arcuate surfaces may be substantially the same or may be different. The convex arcuate raised bump 2906a protrudes from a portion of the contact surface 2906 generally associated with Arc 10 (e.g., see FIG. 9). In any of the described embodiments, the radii and their center points may be set sufficient to form the desired gap “G4” between the contact surface 2906 and the top wall 636 of the wedge 622. A factor that determines the size of the gap “G4” and thus the radii as well as the positioning and dimensions of the raised bump 2906a includes the size or size range of the tap conductors 810 the interface 2900 is designed to connect to.

Either the first side wall 2900c or the second side wall 2900d of interface 2900 includes mounting element 2908, e.g., a channel, configured and dimensioned to interact with the connecting members 750. As described above with respect to earlier embodiments (e.g., see FIG. 2), the connecting members 750 are provided to be attached to the interface 2900 and to mate the interface 2900 to the frame 1050 so that the interface 2900 can flex and move when installing the main conductor 800 and the tap conductor 810 into the connector 1000, as described above with respect to FIGS. 12-17.

An interface according to another illustrative embodiment of the present disclosure is shown in FIG. 11I and is referred to herein as interface 3100. A bottom portion 3100e of the second side wall 3100d is flat and extends at an angle from side wall 3100d. In addition to having different possible shapes (e.g., flat, convex, etc.) and angles, it will be appreciated the bottom portion 3100e of the second side wall 3100d may have various lengths. For example, as depicted in FIG. 11I, bottom portion 3100e extends from second side wall 3100d and is substantially longer than other embodiments (e.g., see FIG. 11E, 11G). According to the present illustrative embodiment, bottom portion 3100e may be configured to conform to the contact surface 644 of the wedge 622. According to this embodiment, the bottom portion 3100e of the second side wall 3100d extends below an imaginary line extending from a lower side 3102a of tab 3102. Bottom portion 3100e may be configured to conform to the contact surface 644 of the wedge and is arranged so that as the wedge tightens the conductor directly and/or indirectly to the frame 1050, the contact surface 644 of the wedge 622 does not interfere with the operation of the interface 3100, as shown and described above with respect to earlier embodiments. A tab 3102 may extend from either the first side wall 3100c or the second side wall 3100d of the interface 3100. Preferably, the tab 3102 extends from a lower portion of the side wall 3100c so that the tab 3102 is substantially perpendicular to at least a portion of the side wall 3100c. It is noted however, that the tab 3102 may be at a non-perpendicular angle relative to the side wall 3100c. Tab 3102 may also act as a lead-in for inserting a tap conductor between the contact surface 644 of the wedge 622 and a contact surface 3106 formed in a lower surface of the interface 3100. More specifically, when a force applied by the tap conductor 810 to tab 3102, the tab acting as a lead-in radially flexes toward the conductor contact wall 682 of the frame 1050 extending the leg 754 of the connecting member 750. The tab 3102 may have an aperture (not shown) configured to interact with an extendible reach tool.

The contact surface 3104 is configured and dimensioned to receive or fit at least partially around a main conductor 800. The contact surface 3106 is formed in a lower surface of the interface 3100. The contact surface 3106 may include an optional bump 3106a which extends across at least a portion of the length “L6” of the interface 3100 and preferably across the entire length “L6” of the interface 3100. The contact surface 3106 is configured and dimensioned to receive or fit at least partially around a tap conductor 810. As described above with respect to earlier embodiments, the contact surface 3106 may also be configured and dimensioned to form a gap “G4” between the contact surface 3106 and the top wall 636 of the wedge 622 and a gap “G5” between the optional bump 3106a and the contact surface 644 as shown and described above with respect to FIG. 6. The gap “G4” is provided so that at least a portion of the contact surface 3106 does not contact the top wall 636 of the wedge 622 when tightening the wedge 622 to the frame 1050. Optional bump 3106a is dimensioned and positioned on contact surface 3106 so that the gap “G5” also assures that the bump 3106a does not contact the contact surface 644 of wedge 622 when tightening the wedge 622 to the frame 1050. The contact surface 3106 may also be configured and dimensioned to urge or push the tap conductor 810, especially smaller size tap conductors, in a direction “C” so that a larger surface area of the tap conductor 810 contacts the contact surface 3106 and urges the tap conductor 810 toward bump 3106a of the interface 3100, similar to that shown and described above with respect to FIGS. 4-6. As the tap conductor 810 is being pressed between the contact surface 3106 and the contact surface 644 of the wedge 622, the bump 3106a will prevent or limit potential unraveling of the strands from the tap conductor 810. As a non-limiting example, the shape of the contact surface 3106 can be considered to have two concave arcuate surfaces with different radii and an optional convex arcuate raised bump 3106a similar to that described above. As depicted in various embodiments to be described herein the differences in radii of the two concave arcuate surfaces may be substantially the same or may be different. The convex arcuate raised bump 3106a protrudes from a portion of the contact surface 3106 generally associated with Arc 10 (e.g., see FIG. 9). In any of the described embodiments, the radii and their center points may be set sufficient to assure the formation of the desired gap “G4” between the contact surface 3106 and the top wall 636 of the wedge 622. A factor that determines the size of the gap “G4” and thus the radii as well as the positioning and dimensions of the raised bump 3106a includes the size or size range of the tap conductors 810 the interface 3100 is designed to connect to.

Either the first side wall 3100c or the second side wall 3100d of interface 3100 includes mounting element 3108, e.g., a channel, configured and dimensioned to interact with the connecting members 750. As described above with respect to earlier embodiments (e.g., see FIG. 2), the connecting members 750 are provided to be attached to the interface 3100 and to mate the interface 3100 to the frame 1050 so that the interface 3100 can flex and move when installing the main conductor 800 and the tap conductor 810 into the connector 1000, as described above with respect to FIGS. 12-17.

An interface according to another illustrative embodiment of the present disclosure is shown in FIG. 11J and is referred to herein as interface 3200. According to the present illustrative embodiment, bottom portion 3200e is flat and may be configured to conform to the contact surface 644 of the wedge 622. According to this embodiment, the bottom portion 3200e of the second side wall 3200d extends below an imaginary line extending from a lower side 3202a of tab 3202. Bottom portion 3200e may be configured to conform to the contact surface 644 of the wedge and is arranged so that as the wedge tightens the conductor directly and/or indirectly to the frame 1050, the contact surface 644 of the wedge 622 does not interfere with the operation of the interface 3200, as shown and described above with respect to earlier embodiments. A tab 3202 may extend from either the first side wall 3200c or the second side wall 3200d of the interface 3200. Preferably, the tab 3202 extends from a lower portion of the side wall 3200c so that the tab 3202 is substantially perpendicular to at least a portion of the side wall 3200c. It is noted however, that the tab 3202 may be at a non-perpendicular angle relative to the side wall 3200c. Tab 3202 may also act as a lead-in for inserting a tap conductor between the contact surface 644 of the wedge 622 and a contact surface 3206 formed in a lower surface of the interface 3200. More specifically, when a force applied by the tap conductor 810 to tab 3202, the tab acting as a lead-in radially flexes toward the conductor contact wall 682 of the frame 1050 extending the leg 754 of the connecting member 750. The tab 3202 may have an aperture (not shown) configured to interact with an extendible reach tool.

The contact surface 3204 is configured and dimensioned to receive or fit at least partially around a main conductor 800. The contact surface 3206 is formed in a lower surface of the interface 3200. The contact surface 3106 may include an optional bump 3206a which extends across at least a portion of the length “L6” of the interface 3200 and preferably across the entire length “L6” of the interface 3200. The contact surface 3206 is configured and dimensioned to receive or fit at least partially around a tap conductor 810. As described above with respect to earlier embodiments, the contact surface 3206 may also be configured and dimensioned to form a gap “G4” between the contact surface 3206 and the top wall 636 of the wedge 622 and a gap “G5” between the optional bump 3206a and the contact surface 644 as shown and described above with respect to FIG. 6. The gap “G4” is provided so that at least a portion of the contact surface 3206 does not contact the top wall 636 of the wedge 622 when tightening the wedge 622 to the frame 1050. Optional bump 3206a is dimensioned and positioned on contact surface 3206 so that the gap “G5” also assures that the bump 3206a does not contact the contact surface 644 of the wedge 622 when tightening the wedge 622 to the frame 1050. The contact surface 3206 may also be configured and dimensioned to urge or push the tap conductor 810, especially smaller size tap conductors, in a direction “C” so that a larger surface area of the tap conductor 810 contacts the contact surface 3206 and urges the tap conductor 810 toward bump 3206a of the interface 3200, similar to that shown and described above with respect to FIGS. 4-6. As the tap conductor 810 is being pressed between the contact surface 3206 and the contact surface 644 of the wedge 622, the bump 3206a will prevent or limit potential unraveling of the strands from the tap conductor 810. As a non-limiting example, the shape of the contact surface 3206 can be considered to have two concave arcuate surfaces with different radii and an optional convex arcuate raised bump 3206a similar to that described above. As depicted in various embodiments to be described herein the radii of the two concave arcuate surfaces may be substantially the same or may be different. The convex arcuate raised bump 3206a protrudes from a portion of the contact surface 3206 generally associated with Arc 10 (e.g., see FIG. 9). In any of the described embodiments, the radii and their center points may be set sufficient to assure the formation of the desired gap “G4” between the contact surface 3206 and the top wall 636 of the wedge 622. A factor that determines the size of the gap “G4” and thus the radii as well as the positioning and dimensions of the raised bump 3206a includes the size or size range of the tap conductors 810 the interface 3200 is designed to connect to.

Either the first side wall 3200c or the second side wall 3200d of interface 3200 includes mounting element 3208, e.g., a channel, configured and dimensioned to interact with the connecting members 750. As described above with respect to earlier embodiments (e.g., see FIG. 2), the connecting members 750 are provided to be attached to the interface 3200 and to mate the interface 3200 to the frame 1050 so that the interface 3200 can flex and move when installing the main conductor 800 and the tap conductor 810 into the connector 1000, as described above with respect to FIGS. 12-17.

An interface according to another illustrative embodiment of the present disclosure is shown in FIG. 11K and is referred to herein as interface 3300. According to the present illustrative embodiment, bottom portion 3300e is flat and extends at an angle from second side wall 3300d and may be configured to conform to the contact surface 644 of the wedge 622. According to this embodiment, the bottom portion 3300e of the second side wall 3300d extends below an imaginary line extending from a lower side 3302a of tab 3302. Bottom portion 3300e may be configured to conform to the contact surface 644 of the wedge and is arranged so that as the wedge tightens the conductor directly and/or indirectly to the frame 1050, the contact surface 644 of the wedge 622 does not interfere with the operation of the interface 3300, as shown and described above with respect to earlier embodiments. A tab 3302 may extend from either the first side wall 3300c or the second side wall 3300d of the interface 3300. Preferably, the tab 3302 extends from a lower portion of the side wall 3300c so that the tab 3302 is substantially perpendicular to at least a portion of the side wall 3300c. It is noted however, that the tab 3302 may be at a non-perpendicular angle relative to the side wall 3300c. Tab 3302 may also act as a lead-in for inserting a tap conductor between the contact surface 644 of the wedge 622 and a contact surface 3306 formed in a lower surface of the interface 3300. More specifically, when a force applied by the tap conductor 810 to tab 3302, the tab acting as a lead-in radially flexes toward the conductor contact wall 682 of the frame 1050 extending the leg 754 of the connecting member 750. The tab 3302 may have an aperture (not shown) configured to interact with an extendible reach tool.

The contact surface 3304 is configured and dimensioned to receive or fit at least partially around a main conductor 800. The contact surface 3306 is formed in a lower surface of the interface 3300. The contact surface 3306 may include an optional bump 3306a which extends across at least a portion of the length “L6” of the interface 3300 and preferably across the entire length “L6” of the interface 3300. The contact surface 3306 is configured and dimensioned to receive or fit at least partially around a tap conductor 810. As described above with respect to earlier embodiments, the contact surface 3306 may also be configured and dimensioned to form a gap “G4” between the contact surface 3306 and the top wall 636 of the wedge 622 and a gap “G5” between the optional bump 3306a and the contact surface 644 as shown and described above with respect to FIG. 6. The gap “G4” is provided so that at least a portion of the contact surface 3306 does not contact the top wall 636 of the wedge 622 when tightening the wedge 622 to the frame 1050. Optional bump 3306a is dimensioned and positioned on contact surface 3306 so that the gap “G5” also assures that the bump 3306a does not contact the contact surface 644 of the wedge 622 when tightening the wedge 622 to the frame 1050. The contact surface 3306 may also be configured and dimensioned to urge or push the tap conductor 810, especially smaller size tap conductors, in a direction “C” so that a larger surface area of the tap conductor 810 contacts the contact surface 3306 and urges the tap conductor 810 toward bump 3306a of the interface 3300, similar to that shown and described above with respect to FIGS. 4-6. As the tap conductor 810 is being pressed between the contact surface 3306 and the contact surface 644 of the wedge 622, the bump 3306a will prevent or limit potential unraveling of the strands from the tap conductor 810. As a non-limiting example, the shape of the contact surface 3306 can be considered to have two concave arcuate surfaces with different radii and an optional convex arcuate raised bump 3306a similar to that described above. As depicted in various embodiments to be described herein the differences in radii of the two concave arcuate surfaces may be substantially the same or may be different. The convex arcuate raised bump 3306a protrudes from a portion of the contact surface 3306 generally associated with Arc 10 (e.g., see FIG. 9). In any of the described embodiments, the radii and their center points may be set sufficient to assure the formation of the desired gap “G4” between the contact surface 3306 and the top wall 636 of the wedge 622. A factor that determines the size of the gap “G4” and thus the radii as well as the positioning and dimensions of the raised bump 3306a includes the size or size range of the tap conductors 810 the interface 3300 is designed to connect to.

Either the first side wall 3300c or the second side wall 3300d of interface 3300 includes mounting element 3308, e.g., a channel, configured and dimensioned to interact with the connecting members 750. As described above with respect to earlier embodiments (e.g., see FIG. 2), the connecting members 750 are provided to be attached to the interface 3300 and to mate the interface 3300 to the frame 1050 so that the interface 3300 can flex and move when installing the main conductor 800 and the tap conductor 810 into the connector 1000, as described above with respect to FIGS. 12-17.

An interface according to another illustrative embodiment of the present disclosure is shown in FIG. 11L and is referred to herein as interface 3400. According to the present illustrative embodiment, bottom portion 3400e has a flat shape and may be configured to conform to the contact surface 644 of the wedge 622. According to this embodiment, the bottom portion 3400e of the second side wall 3400d extends below an imaginary line extending from a lower side 3402a of tab 3402. Bottom portion 3400e may be configured to conform to the contact surface 644 of the wedge and is arranged so that as the wedge tightens the conductor directly and/or indirectly to the frame 1050, the contact surface 644 of the wedge 622 does not interfere with the operation of the interface 3400, as shown and described above with respect to earlier embodiments. A tab 3402 may extend from either the first side wall 3400c or the second side wall 3400d of the interface 3400. Preferably, the tab 3402 extends from a lower portion of the side wall 3400c so that the tab 3402 is substantially perpendicular to at least a portion of the side wall 3400c. It is noted however, that the tab 3402 may be at a non-perpendicular angle relative to the side wall 3400c. Tab 3402 may also act as a lead-in for inserting a tap conductor between the contact surface 644 of the wedge 622 and a contact surface 3406 formed in a lower surface of the interface 3400. More specifically, when a force applied by the tap conductor 810 to tab 3402, the tab acting as a lead-in radially flexes toward the conductor contact wall 682 of the frame 1050 extending the leg 754 of the connecting member 750. The tab 3402 may have an aperture (not shown) configured to interact with an extendible reach tool.

The contact surface 3404 is configured and dimensioned to receive or fit at least partially around a main conductor 800. The contact surface 3406 is formed in a lower surface of the interface 3400. The contact surface 3406 may include an optional bump 3406a which extends across at least a portion of the length “L6” of the interface 3400 and preferably across the entire length “L6” of the interface 3400. The contact surface 3406 is configured and dimensioned to receive or fit at least partially around a tap conductor 810. As described above with respect to earlier embodiments, the contact surface 3406 may also be configured and dimensioned to form a gap “G4” between the contact surface 3406 and the top wall 636 of the wedge 622 and a gap “G5” between the optional bump 3406a and the contact surface 644 as shown and described above with respect to FIG. 6. The gap “G4” is provided so that at least a portion of the contact surface 3406 does not contact the top wall 636 of the wedge 622 when tightening the wedge 622 to the frame 1050. Optional bump 3406a is dimensioned and positioned on contact surface 3406 so that the gap “G5” also assures that the bump 3406a does not contact the contact surface 644 of the wedge 622 when tightening the wedge 622 to the frame 1050. The contact surface 3406 may also be configured and dimensioned to urge or push the tap conductor 810, especially smaller size tap conductors, in a direction “C” so that a larger surface area of the tap conductor 810 contacts the contact surface 3406 and urges the tap conductor 810 toward bump 3406a of the interface 3400, similar to that shown and described above with respect to FIGS. 4-6. As the tap conductor 810 is being pressed between the contact surface 3406 and the contact surface 644 of the wedge 622, the bump 3406a will prevent or limit potential unraveling of the strands from the tap conductor 810. As a non-limiting example, the shape of the contact surface 3406 can be considered to have two concave arcuate surfaces with different radii and an optional convex arcuate raised bump 3406a similar to that described above. As depicted in various embodiments to be described herein the differences in radii of the two concave arcuate surfaces may be substantially the same or may be different. The convex arcuate raised bump 3406a protrudes from a portion of the contact surface 3406 generally associated with Arc 10 (e.g., see FIG. 9). In any of the described embodiments, the radii and their center points may be set sufficient to assure the formation of the desired gap “G4” between the contact surface 3406 and the top wall 636 of the wedge 622. A factor that determines the size of the gap “G4” and thus the radii as well as the positioning and dimensions of the raised bump 3406a includes the size or size range of the tap conductors 810 the interface 3400 is designed to connect to.

Either the first side wall 3400c or the second side wall 3400d of interface 3400 includes mounting element 3408, e.g., a channel, configured and dimensioned to interact with the connecting members 750. As described above with respect to earlier embodiments (e.g., see FIG. 2), the connecting members 750 are provided to be attached to the interface 3400 and to mate the interface 3100 to the frame 1050 so that the interface 3400 can flex and move when installing the main conductor 800 and the tap conductor 810 into the connector 1000, as described above with respect to FIGS. 12-17.

An interface according to another illustrative embodiment of the present disclosure is shown in FIG. 11M and is referred to herein as interface 3500. According to the present illustrative embodiment, bottom portion 3500e is flat and substantially shorter than other embodiments (e.g., see FIG. 11L) and may be configured to conform to the contact surface 644 of the wedge 622. According to this embodiment, the bottom portion 3500e of the second side wall 3500d extends below an imaginary line extending from a lower side 3502a of tab 3502. Bottom portion 3500e may be configured to conform to the contact surface 644 of the wedge and is arranged so that as the wedge tightens the conductors 800 and 810 directly and/or indirectly to the frame 1050, the contact surface 644 of the wedge 622 does not interfere with the operation of the interface 3500, as shown and described above with respect to earlier embodiments. A tab 3502 may extend from either the first side wall 3500c or the second side wall 3500d of the interface 3500. Preferably, the tab 3502 extends from a lower portion of the side wall 3500c so that the tab 3502 is substantially perpendicular to at least a portion of the side wall 3500c. It is noted however, that the tab 3502 may be at a non-perpendicular angle relative to the side wall 3500c. Tab 3502 may also act as a lead-in for inserting a tap conductor between the contact surface 644 of the wedge 622 and a contact surface 3506 formed in a lower surface of the interface 3500. More specifically, when a force applied by the tap conductor 810 to tab 3502, the tab acting as a lead-in radially flexes toward the conductor contact wall 682 of the frame 1050 extending the leg 754 of the connecting member 750. The tab 3502 may have an aperture (not shown) configured to interact with an extendible reach tool.

The contact surface 3504 is configured and dimensioned to receive or fit at least partially around a main conductor 800. The contact surface 3506 is formed in a lower surface of the interface 3500. The contact surface 3506 may include an optional bump 3506a which extends across at least a portion of the length “L6” of the interface 3500 and preferably across the entire length “L6” of the interface 3500. The contact surface 3506 is configured and dimensioned to receive or fit at least partially around a tap conductor 810. As described above with respect to earlier embodiments, the contact surface 3506 may also be configured and dimensioned to form a gap “G4” between the contact surface 3506 and the top wall 636 of the wedge 622 and a gap “G5” between the optional bump 3506a and the contact surface 644 as shown and described above with respect to FIG. 6. The gap “G4” is provided so that at least a portion of the contact surface 3506 does not contact the top wall 636 of the wedge 622 when tightening the wedge 622 to the frame 1050. Optional bump 3506a is dimensioned and positioned on contact surface 3506 so that the gap “G5” also assures that the bump 3506a does not contact the contact surface 644 of the wedge 622 when tightening the wedge 622 to the frame 1050. The contact surface 3506 may also be configured and dimensioned to urge or push the tap conductor 810, especially smaller size tap conductors, in a direction “C” so that a larger surface area of the tap conductor 810 contacts the contact surface 3506 and urges the tap conductor 810 toward bump 3506a of the interface 3500, similar to that shown and described above with respect to FIGS. 4-6. As the tap conductor 810 is being pressed between the contact surface 3506 and the contact surface 644 of the wedge 622, the bump 3506a will prevent or limit potential unraveling of the strands from the tap conductor 810. As a non-limiting example, the shape of the contact surface 3506 can be considered to have two concave arcuate surfaces with different radii and an optional convex arcuate raised bump 3506a similar to that described above. As depicted in various embodiments to be described herein the radii of the two concave arcuate surfaces may be substantially the same or may be different. The convex arcuate raised bump 3506a protrudes from a portion of the contact surface 3506 generally associated with Arc 10 (e.g., see FIG. 9). In any of the described embodiments, the radii and their center points may be set sufficient to assure the formation of the desired gap “G4” between the contact surface 3506 and the top wall 636 of the wedge 622. A factor that determines the size of the gap “G4” and thus the radii as well as the positioning and dimensions of the raised bump 3506a includes the size or size range of the tap conductors 810 the interface 3500 is designed to connect to.

Either the first side wall 3500c or the second side wall 3500d of interface 3500 includes mounting element 3508, e.g., a channel, configured and dimensioned to interact with the connecting members 750. As described above with respect to earlier embodiments (e.g., see FIG. 2), the connecting members 750 are provided to be attached to the interface 3500 and to mate the interface 3500 to the frame 1050 so that the interface 3500 can flex and move when installing the main conductor 800 and the tap conductor 810 into the connector 1000, as described above with respect to FIGS. 12-17.

An interface according to another illustrative embodiment of the present disclosure is shown in FIG. 11N and is referred to herein as interface 3600. According to the present illustrative embodiment, bottom portion 3600e is flat and extends at an angle from second side wall 3600d. According to this embodiment, the bottom portion 3600e of the second side wall 3600d extends below an imaginary line extending from a lower side 3602a of tab 3602. Bottom portion 3600e may be configured to conform to the contact surface 644 of the wedge and is arranged so that as the wedge tightens the conductor directly and/or indirectly to the frame 1050, the contact surface 644 of the wedge 622 does not interfere with the operation of the interface 3600, as shown and described above with respect to earlier embodiments. A tab 3602 may extend from either the first side wall 3600c or the second side wall 3600d of the interface 3600. Preferably, the tab 3602 extends from a lower portion of the side wall 3600c so that the tab 3602 is substantially perpendicular to at least a portion of the side wall 3600c. It is noted however, that the tab 3602 may be at a non-perpendicular angle relative to the side wall 3600c. Tab 3602 may also act as a lead-in for inserting a tap conductor between the contact surface 644 of the wedge 622 and a contact surface 3606 formed in a lower surface of the interface 3600. More specifically, when a force applied by the tap conductor 810 to tab 3602, the tab acting as a lead-in radially flexes toward the conductor contact wall 682 of the frame 1050 extending the leg 754 of the connecting member 750. The tab 3602 may have an aperture (not shown) configured to interact with an extendible reach tool.

The contact surface 3604 is configured and dimensioned to receive or fit at least partially around a main conductor 800. The contact surface 3606 is formed in a lower surface of the interface 3600. The contact surface 3606 may include an optional bump 3606a which extends across at least a portion of the length “L6” of the interface 3600 and preferably across the entire length “L6” of the interface 3600. The contact surface 3606 is configured and dimensioned to receive or fit at least partially around a tap conductor 810. As described above with respect to earlier embodiments, the contact surface 3606 may also be configured and dimensioned to form a gap “G4” between the contact surface 3606 and the top wall 636 of the wedge 622 and a gap “G5” between the optional bump 3606a and the contact surface 644 as shown and described above with respect to FIG. 6. The gap “G4” is provided so that at least a portion of the contact surface 3606 does not contact the top wall 636 of the wedge 622 when tightening the wedge 622 to the frame 1050. Optional bump 3606a is dimensioned and positioned on contact surface 3606 so that the gap “G5” also assures that the bump 3606a does not contact the contact surface 644 of the wedge 622 when tightening the wedge 622 to the frame 1050. The contact surface 3606 may also be configured and dimensioned to urge or push the tap conductor 810, especially smaller size tap conductors, in a direction “C” so that a larger surface area of the tap conductor 810 contacts the contact surface 3606 and urges the tap conductor 810 toward bump 3606a of the interface 3600, similar to that shown and described above with respect to FIGS. 4-6. As the tap conductor 810 is being pressed between the contact surface 3606 and the contact surface 644 of the wedge 622, the bump 3606a will prevent or limit potential unraveling of the strands from the tap conductor 810. As a non-limiting example, the shape of the contact surface 3606 can be considered to have two concave arcuate surfaces with different radii and an optional convex arcuate raised bump 3606a similar to that described above. As depicted in various embodiments described herein the radii of the two concave arcuate surfaces may be substantially the same or may be different. The convex arcuate raised bump 3606a protrudes from a portion of the contact surface 3606 generally associated with Arc 10 (e.g., see FIG. 9). In any of the described embodiments, the radii and their center points may be set sufficient to assure the formation of the desired gap “G4” between the contact surface 3606 and the top wall 636 of the wedge 622. A factor that determines the size of the gap “G4” and thus the radii as well as the positioning and dimensions of the raised bump 3606a includes the size or size range of the tap conductors 810 the interface 3600 is designed to connect to.

Either the first side wall 3600c or the second side wall 3600d of interface 3600 includes mounting element 3608, e.g., a channel, configured and dimensioned to interact with the connecting members 750. As described above with respect to earlier embodiments (e.g., see FIG. 2), the connecting members 750 are provided to be attached to the interface 3600 and to mate the interface 3600 to the frame 1050 so that the interface 3600 can flex and move when installing the main conductor 800 and the tap conductor 810 into the connector 1000, as described above with respect to FIGS. 12-17.

An interface according to another illustrative embodiment of the present disclosure is shown in FIG. 11O and is referred to herein as interface 3700. According to the present illustrative embodiment, bottom portion 3700e has a slight arcuate shape and extends at an angle from second side wall 3700d. According to this embodiment, the bottom portion 3700e of the second side wall 3700d extends below an imaginary line extending from a lower side 3702a of tab 3702. Bottom portion 3700e may be configured to conform to the contact surface 644 of the wedge and is arranged so that as the wedge tightens the conductor directly and/or indirectly to the frame 1050, the contact surface 644 of the wedge 622 does not interfere with the operation of the interface 3700, as shown and described above with respect to earlier embodiments. A tab 3702 may extend from either the first side wall 3700c or the second side wall 3700d of the interface 3700. Preferably, the tab 3702 extends from a lower portion of the side wall 3700c so that the tab 3702 is substantially perpendicular to at least a portion of the side wall 3700c. It is noted however, that the tab 3702 may be at a non-perpendicular angle relative to the side wall 3700c. Tab 3702 may also act as a lead-in for inserting a tap conductor between the contact surface 644 of the wedge 622 and a contact surface 3706 formed in a lower surface of the interface 3700. More specifically, when a force applied by the tap conductor 810 to tab 3702, the tab acting as a lead-in radially flexes toward the conductor contact wall 682 of the frame 1050 extending the leg 754 of the connecting member 750. The tab 3702 may have an aperture (not shown) configured to interact with an extendible reach tool.

The contact surface 3704 is configured and dimensioned to receive or fit at least partially around a main conductor 800. The contact surface 3706 is formed in a lower surface of the interface 3700. The contact surface 3706 may include an optional bump 3706a which extends across at least a portion of the length “L6” of the interface 3700 and preferably across the entire length “L6” of the interface 3700. The contact surface 3706 is configured and dimensioned to receive or fit at least partially around a tap conductor 810. As described above with respect to earlier embodiments, the contact surface 3706 may also be configured and dimensioned to form a gap “G4” between the contact surface 3706 and the top wall 636 of the wedge 622 and a gap “G5” between the optional bump 3706a and the contact surface 644 as shown and described above with respect to FIG. 6. The gap “G4” is provided so that at least a portion of the contact surface 3706 does not contact the top wall 636 of the wedge 622 when tightening the wedge 622 to the frame 1050. Optional bump 3706a is dimensioned and positioned on contact surface 3706 so that the gap “G5” also assures that the bump 3706a does not contact the contact surface 644 of the wedge 622 when tightening the wedge 622 to the frame 1050. The contact surface 3706 may also be configured and dimensioned to urge or push the tap conductor 810, especially smaller size tap conductors, in a direction “C” so that a larger surface area of the tap conductor 810 contacts the contact surface 3706 and urges the tap conductor 810 toward bump 3706a of the interface 3700, similar to that shown and described above with respect to FIGS. 4-6. As the tap conductor 810 is being pressed between the contact surface 3706 and the contact surface 644 of the wedge 622, the bump 3706a will prevent or limit potential unraveling of the strands from the tap conductor 810. As a non-limiting example, the shape of the contact surface 3706 can be considered to have two concave arcuate surfaces with different radii and an optional convex arcuate raised bump 3706a similar to that described above. As depicted in various embodiments described herein the radii of the two concave arcuate surfaces may be substantially the same or may be different. The convex arcuate raised bump 3706a protrudes from a portion of the contact surface 3706 generally associated with Arc 10 (e.g., see FIG. 9). In any of the described embodiments, the radii and their center points may be set sufficient to assure the formation of the desired gap “G4” between the contact surface 3706 and the top wall 636 of the wedge 622. A factor that determines the size of the gap “G4” and thus the radii as well as the positioning and dimensions of the raised bump 3706a includes the size or size range of the tap conductors 810 the interface 3700 is designed to connect to.

Either the first side wall 3700c or the second side wall 3700d of interface 3700 includes mounting element 3708, e.g., a channel, configured and dimensioned to interact with the connecting members 750. As described above with respect to earlier embodiments (e.g., see FIG. 2), the connecting members 750 are provided to be attached to the interface 3700 and to mate the interface 3700 to the frame 1050 so that the interface 3700 can flex and move when installing the main conductor 800 and the tap conductor 810 into the connector 1000, as described above with respect to FIGS. 12-17.

An interface according to another illustrative embodiment of the present disclosure is shown in FIG. 11P and is referred to herein as interface 3800. According to the present illustrative embodiment, bottom portion 3800e of second side wall 3800d is flat and extends at an angle from second side wall 3800d and may be configured to conform to the contact surface 644 of the wedge 622. According to this embodiment, the bottom portion 3800e of the second side wall 3800d is substantially even with an imaginary line extending from a lower side 3802a of tab 3802. Bottom portion 3800e may be configured to conform to the contact surface 644 of the wedge and is arranged so that as the wedge tightens the conductor directly and/or indirectly to the frame 1050, the contact surface 644 of the wedge 622 does not interfere with the operation of the interface 3800, as shown and described above with respect to earlier embodiments. A tab 3802 may extend from either the first side wall 3800c or the second side wall 3800d of the interface 3800. Preferably, the tab 3802 extends from a lower portion of the side wall 3800c so that the tab 3802 is substantially perpendicular to at least a portion of the side wall 3800c. It is noted however, that the tab 3802 may be at a non-perpendicular angle relative to the side wall 3800c. Tab 3802 may also act as a lead-in for inserting a tap conductor between the contact surface 644 of the wedge 622 and a contact surface 3806 formed in a lower surface of the interface 3800. More specifically, when a force applied by the tap conductor 810 to tab 3802, the tab acting as a lead-in radially flexes toward the conductor contact wall 682 of the frame 1050 extending the leg 754 of the connecting member 750. The tab 3802 may have an aperture (not shown) configured to interact with an extendible reach tool.

The contact surface 3804 is formed in an upper surface of the interface 3800. The contact surface 3804 is configured and dimensioned to receive or fit at least partially around a main conductor 800. The top portion 3800f of first side wall 3800c may have various lengths and extend at various angles from first side wall 3800c. For example, as depicted in FIG. 11P, the top portion 3800f is flat and is substantially longer than other embodiments and extends at a sharper angle “K” from first side wall 3800c than other described embodiments (e.g., see FIGS. 11D-11F). The angle “K” may generally be between 90 degrees and 180 degrees. The contact surface 3806 is formed in a lower surface of the interface 3800. The distance “d” between the contact surface 3804 and contact surface 3806 may vary depending on various factors including, for example, the size or size range of the main and tap conductors the interface 3800, the size and/or configuration of the wedge 626 and/or frame 1050 the interface is designed to connect to. According to the present embodiment, the distance “d” between contact surfaces 3804 and 3806 is substantially less than other embodiments (e.g., see FIGS. 11B and 11C).

The contact surface 3806 may include an optional bump 3806a which extends across at least a portion of the length “L6” of the interface 3800 and preferably across the entire length “L6” of the interface 3800. Contact surface 3806 is configured and dimensioned to receive or fit at least partially around a tap conductor 810. The contact surface 3806 may also be configured and dimensioned to form a gap (similar to gap “G4” described above) between the contact surface 3806 and the top wall 636 of the wedge 622. As described with respect to above embodiments, the gap “G4” is provided so that at least a portion of the contact surface 3806 does not contact the top wall 636 of the wedge 622 when tightening the wedge 622 to the frame 1050. The gap “G4” also assures that the optional bump 3806a does not contact the contact surface 644 when tightening the wedge 622 to the frame 1050. The contact surface 3806 may also be configured and dimensioned to urge or push the tap conductor 810, especially intermediate and smaller size tap conductors, in a direction “C” (e.g., similar to that shown and described with respect to FIG. 6) so that a larger surface area of the tap conductor 810 contacts the contact surface 3806 as well as optional bump 3806a of the interface 3800. As the tap conductor 810 is being pressed between the contact surface 3806 and the contact surface 644 of the wedge 622, the bump 3806a will prevent or limit potential unraveling of the strands from the tap conductor 810. As a non-limiting example, the shape of the contact surface 3806 can be considered to have two concave arcuate surfaces with different radii and an optional convex arcuate raised bump 3806a similar to that described above. The convex arcuate raised bump 3806a protrudes from a portion of the contact surface 3806 generally associated with Arc 10 (e.g., see FIG. 9). For example, according to the present embodiment, the radii of the two concave arcuate surfaces are substantially different. In any of the described embodiments, the radii and their center points may be set sufficient to assure the formation of the desired gap “G4” between the contact surface 3806 and the top wall 636 of the wedge 622. A factor that determines the size of the gap “G4” and thus the radii as well as the positioning and dimensions of the raised bump 3806a includes the size or size range of the tap conductors 810 the interface 3800 is designed to connect to.

Either the first side wall 3800c or the second side wall 3800d of interface 3800 includes mounting element 3808, e.g., a channel, configured and dimensioned to interact with the connecting members 750. As described above with respect to earlier embodiments (e.g., see FIG. 2), the connecting members 750 are provided to be attached to the interface 3800 and to mate the interface 3800 to the frame 1050 so that the interface 3800 can flex and move when installing the main conductor 800 and the tap conductor 810 into the connector 1000, as described above with respect to FIGS. 12-17.

An interface according to another illustrative embodiment of the present disclosure is shown in FIG. 11Q and is referred to herein as interface 3900. A bottom portion 3900e of the second side wall 3900d is substantially straight and comes to a rounded point as shown. According to the present illustrative embodiment, the rounded point and bottom portion 3900e may be configured to conform to the contact surface 644 of the wedge 622 so that as the wedge tightens the conductors 800 and 810 directly and/or indirectly to the frame 1050, contact surface 644 of the wedge 622 does not interfere with the operation of the interface 3900, as shown in the above-described embodiments. A tab 3902 may extend from either the first side wall 3900c or the second side wall 3900d of the interface 3900. Preferably, the tab 3902 extends from a lower portion of the side wall 3900c so that the tab 3902 is substantially perpendicular to at least a portion of the side wall 3900c. It is noted however, that the tab 3902 may be at a non-perpendicular angle relative to the side wall 3900c. Tab 3902 may also act as a lead-in for inserting a tap conductor between the contact surface 644 of the wedge 622 and a contact surface 3906 formed in a lower surface of the interface 3900. More specifically, when a force applied by the tap conductor 810 to tab 3902, the tab acting as a lead-in radially flexes toward the conductor contact wall 682 of the frame 1050 extending the leg 754 of the connecting member 750. The tab 3902 may have an aperture (not shown) configured to interact with an extendible reach tool.

The contact surface 3904 is formed in an upper surface of the interface 3900 and is substantially similar to the contact surfaces on the upper surface of the other interfaces described herein. The contact surface 3904 is configured and dimensioned to receive or fit at least partially around a main conductor 800. The contact surface 3906 is formed in a lower surface of the interface 3900. According to the present embodiment, the distance between contact surfaces 3904 and 3906 is substantially less than other embodiments and even less than that depicted in FIG. 11P. As noted above with respect to FIG. 11P, the distance between the contact surface 3904 and the contact surface 3906 may vary depending on various factors including, for example, on the size or size range of the main and tap conductors the interface 3900 is designed to connect to.

The contact surface 3906 may include an optional bump 3906a similar to the bumps described in previous embodiment. Contact surface 3906 is configured and dimensioned to receive or fit at least partially around a tap conductor 810. The contact surface 3906 may also be configured and dimensioned to form a gap (similar to gap “G4” described above) between the contact surface 3906 and the top wall 636 of the wedge 622. As described above, the gap “G4” is provided so that at least a portion of the contact surface 3906 does not contact the top wall 636 of the wedge 622 when tightening the wedge 622 to the frame 1050. The gap “G4” also assures that the optional bump 3906a does not contact the contact surface 644 when tightening the wedge 622 to the frame 1050. The contact surface 3906 may also be configured and dimensioned to urge or push the tap conductor 810, especially intermediate and smaller size tap conductors, in a direction “C” (e.g., similar to that shown and described with respect to FIG. 6) so that a larger surface area of the tap conductor 810 contacts the contact surface 3906 as well as the optional bump 3906a of the interface 3900. As the tap conductor 810 is being pressed between the contact surface 3906 and the contact surface 644 of the wedge 622, the bump 3906a will prevent or limit potential unraveling of the strands from the tap conductor 810. As a non-limiting example, the shape of the contact surface 3906 can be considered to have two concave arcuate surfaces with different radii and an optional convex arcuate raised bump 3906a similar to that described above. As depicted in various embodiments described herein the radii of the two concave arcuate surfaces may be substantially the same or may be different. The convex arcuate raised bump 3906a protrudes from a portion of the contact surface 3906 generally associated with Arc 10 (e.g., see FIG. 9). In any of the described embodiments, the radii and their center points may be set sufficient to assure the formation of the desired gap “G4” between the contact surface 3906 and the top wall 636 of the wedge 622. A factor that determines the size of the gap “G4” and thus the radii as well as the positioning and dimensions of the raised bump 3906a includes the size or size range of the tap conductors 810 the interface 3900 is designed to connect to.

Either the first side wall 3900c or the second side wall 3900d of interface 3900 includes mounting element 3908, e.g., a channel, configured and dimensioned to interact with the connecting members 750. As described above with respect to earlier embodiments (e.g., see FIG. 6), the connecting members 750 are provided to be attached to the interface 3900 and to mate the interface 3900 to the frame 1050 so that the interface 3900 can flex and move when installing the main conductor 800 and the tap conductor 810 into the connector 1000, as described above with respect to FIGS. 12-17.

Although depicted in various embodiments as parallel or substantially parallel, the first and second side walls of the interface may be other than parallel to each other. For example, an interface according to another illustrative embodiment of the present disclosure is shown in FIG. 11R and is referred to herein as interface 4100. Interface 4100 includes a first side wall 4100c which extends from tab 4102 at an angle “S” greater than 90 degrees. The angle “S” may generally between 90 and 135 degrees. Top portion 4100f of first side wall 4100c then extends at an angle from side 4100C and transitions to contact surface 4104 as shown. According to the present illustrative embodiment, bottom portion 4100e of side 4100d has a rounded off tip and may be configured to conform to the contact surface 644 of the wedge 622 and is arranged so that as the wedge tightens the conductors 800 and 810 directly and/or indirectly to the frame 1050, the contact surface 644 of the wedge 622 does not interfere with the operation of the interface 4100, as shown in the above-described embodiments. The tab 4102 may extend from either the first side wall 4100c or the second side wall 4100d of the interface 4100. According to the present embodiment, the tab 4102 extends from a lower portion of the side wall and is not perpendicular to the side wall 4100c. Tab 4102 may also act as a lead-in for inserting a tap conductor between the contact surface 644 of the wedge 622 and a contact surface 4106 formed in a lower surface of the interface 4100. More specifically, when a force applied by the tap conductor 810 to tab 4102, the tab acting as a lead-in radially flexes toward the conductor contact wall 682 of the frame 1050 extending the leg 754 of the connecting member 750. The tab 4102 may have an aperture (not shown) configured to interact with an extendible reach tool.

The contact surface 4104 is formed in an upper surface of the interface 4100 and is substantially similar to the contact surfaces on the upper surface of the other interfaces described herein. The contact surface 4104 is configured and dimensioned to receive or fit at least partially around a main conductor 800. The contact surface 4106 is formed in a lower surface of the interface 4100. The contact surface 4106 may include an optional bump 4106a similar to the bumps depicted in previous embodiments. The contact surface 4106 may also be configured and dimensioned to form a gap (similar to gap “G4” described above) between the contact surface 4106 and the top wall 636 of the wedge 622. As described above, the gap “G4” is provided so that at least a portion of the contact surface 4106 does not contact the top wall 636 of the wedge 622 when tightening the wedge 622 to the frame 1050. The gap “G4” also assures that the optional bump 4106a does not contact the contact surface 644 when tightening the wedge 622 to the frame 1050. The contact surface 4106 may also be configured and dimensioned to urge or push the tap conductor 810, especially intermediate and smaller size tap conductors, in a direction “C” (e.g., similar to that shown and described with respect to FIG. 6) so that a larger surface area of the tap conductor 810 contacts the contact surface 4106 as well as optional bump 4106a of the interface 4100. As depicted in various embodiments described herein the radii of the one or more arcuate concave portions forming contact surface 4106 may be substantially the same or may be different. According to the present disclosure, contact surface 4106 includes a substantially straight portion 4106b which extends at an angle from tab 4102. As shown, this portion 4106b may include the optional bump 4106a. Straight portion 4106b then transitions to one or more arcuate concave portions 4106c. The straight portion 4106b and the one or more arcuate concave portions 4106c are configured and dimensioned to receive or fit at least partially around a tap conductor 810. In any of the described embodiments, the length and angle of straight portion 4102b and the radii and the center points of the one or more concave arcuate portions may be set sufficient to assure the formation of the desired gap “G4” between the contact surface 3706 and the top wall 636 of the wedge 622. A factor that determines the size of the gap “G4” and thus the radii as well as the positioning and dimensions of the raised bump 3706a includes the size or size range of the tap conductors 810 the interface 4100 is designed to connect to.

Either the first side wall 4100c or the second side wall 4100d of interface 4100 includes mounting element 4108, e.g., a channel, configured and dimensioned to interact with the connecting members 750. As described above with respect to earlier embodiments (e.g., see FIG. 2), the connecting members 750 are provided to be attached to the interface 4100 and to mate the interface 4100 to the frame 1050 so that the interface 4100 can flex and move when installing the main conductor 800 and the tap conductor 810 into the connector 1000. For reasons of brevity, these connecting members will not be described again in detail.

An interface according to another illustrative embodiment of the present disclosure is shown in FIG. 11S and is referred to herein as interface 4200. Interface 4200 has a first side wall 4200c which includes a first side wall portion 4200f which extends from tab 4202 at an angle greater than 90 degrees similar to that discussed above with respect to FIG. 11R. The angle “S” may generally between 90 and 135 degrees. First side wall portion 4200f of first side wall 4200c then transitions to upper portion 4200g which is parallel to second side wall 4200d. Upper portion 4200g then extends at an angle to portion 4200h which transitions to contact surface 4204 as shown. A bottom portion 4200e of the second side wall 4200d is flat and extends at an angle from second side wall 4200d. According to this embodiment, the bottom portion 4200e of the second side wall 4200d extends below an imaginary line extending from a lower side 4202a of tab 4202. Bottom portion 4200e may be configured to conform to the contact surface 644 of the wedge and is arranged so that as the wedge tightens the conductor directly and/or indirectly to the frame 1050, the contact surface 644 of the wedge 622 does not interfere with the operation of the interface 4200, as shown and described above with respect to earlier embodiments. A tab 4202 may extend from either the first side wall 4200c or the second side wall 4200d of the interface 4200. According to the present illustrative embodiment, bottom portion 4200e of the second side wall 4200d extends below an imaginary line extending from the lower side 4202a of tab 4202. Preferably, the tab 4202 extends from a lower portion of the side wall 4200c so that the tab 4202 is substantially perpendicular to at least a portion of the side wall 4200c. It is noted however, that the tab 4202 may be at a non-perpendicular angle relative to the side wall 4200c. Tab 4202 may also act as a lead-in for inserting a tap conductor between the contact surface 644 of the wedge 622 and a contact surface 4206 formed in a lower surface of the interface 4200. More specifically, when a force applied by the tap conductor 810 to tab 4202, the tab acting as a lead-in radially flexes toward the conductor contact wall 682 of the frame 1050 extending the leg 754 of the connecting member 750. The tab 4202 may have an aperture (not shown) configured to interact with an extendible reach tool.

An upper portion 4200i of second side wall 4200d extends at an angle from second side wall 4200d and transitions to contact surface 4204. The contact surface 4204 is configured and dimensioned to receive or fit at least partially around a main conductor 800. The contact surface 4206 is formed in a lower surface of the interface 4200. The contact surface 4206 includes an optional bump 4206a which extends across at least a portion of the length “L6” of the interface 4200 and preferably across the entire length “L6” of the interface 4200. The contact surface 4206 is configured and dimensioned to receive or fit at least partially around a tap conductor 810. As described above with respect to earlier embodiments, the contact surface 4206 may also be configured and dimensioned to form a gap “G4” between the contact surface 4206 and the top wall 636 of the wedge 622 and a gap “G5” between the bump 4206a and the contact surface 644 as shown and described above with respect to FIG. 6. The gap “G4” is provided so that at least a portion of the contact surface 4206 does not contact the top wall 636 of the wedge 622 when tightening the wedge 622 to the frame 1050. Optional bump 4206a is dimensioned and positioned on contact surface 4206 so that the gap “G5” also assures that the bump 4206a does not contact the contact surface 644 of the wedge 622 when tightening the wedge 622 to the frame 1050. The contact surface 4206 may also be configured and dimensioned to urge or push the tap conductor 810, especially smaller size tap conductors, in a direction “C” so that a larger surface area of the tap conductor 810 contacts the contact surface 4206 and urges the tap conductor 810 toward bump 4206a of the interface 4200, similar to that shown and described above with respect to FIGS. 4-6. As the tap conductor 810 is being pressed between the contact surface 4206 and the contact surface 644 of the wedge 622, the bump 4206a will prevent or limit potential unraveling of the strands from the tap conductor 810. As a non-limiting example, the shape of the contact surface 4206 can be considered to have two concave arcuate surfaces with different radii and a convex arcuate raised bump 4206a similar to that described above. As depicted in various embodiments described herein the differences in radii of the two concave arcuate surfaces may be substantially the same or may be different. The convex arcuate raised bump 4206a protrudes from a portion of the contact surface 4206 generally associated with Arc 10 (e.g., see FIG. 9). In any of the described embodiments, the radii and their center points may be set sufficient to form the desired gap “G4” between the contact surface 4206 and the top wall 636 of the wedge 622. A factor that determines the size of the gap “G4” and thus the radii as well as the positioning and dimensions of the raised bump 4206a includes the size or size range of the tap conductors 810 the interface 4200 is designed to connect to.

Either the first side wall 4200c or the second side wall 4200d of interface 4200 includes mounting element 4208, e.g., a channel, configured and dimensioned to interact with the connecting members 750. As described above with respect to earlier embodiments (e.g., see FIG. 2), the connecting members 750 are provided to be attached to the interface 4200 and to mate the interface 4200 to the frame 1050 so that the interface 4200 can flex and move when installing the main conductor 800 and the tap conductor 810 into the connector 1000, as described above with respect to FIGS. 12-17.

An interface according to another illustrative embodiment of the present disclosure is shown in FIG. 11T and is referred to herein as interface 4300. Interface 4300 has a first side wall 4300c which includes a first side wall portion 4300f which extends from tab 4302 at an angle greater than 90 degrees similar to that discussed above with respect to FIG. 11R. The angle “S” may generally between 90 and 135 degrees. First side wall portion 4300f of first side wall 4300c then transitions to upper portion 4300g which is parallel to second side wall 4300d. Upper portion 4300g extends to rounded point 4300h and transitions to contact surface 4304 as shown. A bottom portion 4300e of the second side wall 4300d is convex and extends at an angle from second side wall 4300d. According to this embodiment, the bottom portion 4300e of the second side wall 4300d is substantially even with an imaginary line extending from a lower side 4302a of tab 4302. Bottom portion 4300e may be configured to conform to the contact surface 644 of the wedge and is arranged so that as the wedge tightens the conductors 800 and 810 directly and/or indirectly to the frame 1050, the contact surface 644 of the wedge 622 does not interfere with the operation of the interface 4300, as shown and described above with respect to earlier embodiments. A tab 4302 may extend from either the first side wall 4300c or the second side wall 4300d of the interface 4300. According to the present illustrative embodiment, bottom portion 4300e of the second side wall 4300d extends below an imaginary line extending from the lower side 4302a of tab 4302. Preferably, the tab 4302 extends from a lower portion of the side wall 4300c so that the tab 4302 is substantially perpendicular to at least a portion of the side wall 4300c. It is noted however, that the tab 4302 may be at a non-perpendicular angle relative to the side wall 4300c. Tab 4302 may also act as a lead-in for inserting a tap conductor between the contact surface 644 of the wedge 622 and a contact surface 4306 formed in a lower surface of the interface 4300. More specifically, when a force applied by the tap conductor 810 to tab 4302, the tab acting as a lead-in radially flexes toward the conductor contact wall 682 of the frame 1050 extending the leg 754 of the connecting member 750. The tab 4302 may have an aperture (not shown) configured to interact with an extendible reach tool.

The contact surface 4304 is configured and dimensioned to receive or fit at least partially around a main conductor 800. The contact surface 4306 is formed in a lower surface of the interface 4300. The contact surface 4306 includes an optional bump 4306a which extends across at least a portion of the length “L6” of the interface 4300 and preferably across the entire length “L6” of the interface 4300. The contact surface 4306 and optional bump 4306a are configured and dimensioned to receive or fit at least partially around a tap conductor 810. As described above with respect to earlier embodiments, the contact surface 4306 may also be configured and dimensioned to form a gap “G4” between the contact surface 4306 and the top wall 636 of the wedge 622 and a gap “G5” between the bump 4306a and the contact surface 644 as shown and described above with respect to FIG. 6. The gap “G4” is provided so that at least a portion of the contact surface 4306 does not contact the top wall 636 of the wedge 622 when tightening the wedge 622 to the frame 1050. Optional bump 4306a is dimensioned and positioned on contact surface 4306 so that the gap “G5” also assures that the bump 4306a does not contact the contact surface 644 of the wedge 622 when tightening the wedge 622 to the frame 1050. The contact surface 4306 may also be configured and dimensioned to urge or push the tap conductor 810, especially smaller size tap conductors, in a direction “C” so that a larger surface area of the tap conductor 810 contacts the contact surface 4306 and urges the tap conductor 810 toward bump 4306a of the interface 4300, similar to that shown and described above with respect to FIGS. 4-6. As the tap conductor 810 is being pressed between the contact surface 4306 and the contact surface 644 of the wedge 622, the bump 4306a will prevent or limit potential unraveling of the strands from the tap conductor 810. As a non-limiting example, the shape of the contact surface 4306 can be considered to have two concave arcuate surfaces with different radii and a convex arcuate raised bump 4306a similar to that described above. As depicted in various embodiments described herein the differences in radii of the two concave arcuate surfaces may be substantially the same or may be different. The convex arcuate raised bump 4306a protrudes from a portion of the contact surface 4306 generally associated with Arc 10 (e.g., see FIG. 9). In any of the described embodiments, the radii and their center points may be set sufficient to form the desired gap “G4” between the contact surface 4306 and the top wall 636 of the wedge 622. A factor that determines the size of the gap “G4” and thus the radii as well as the positioning and dimensions of the raised bump 4306a includes the size or size range of the tap conductors 810 the interface 4300 is designed to connect to.

Either the first side wall 4300c or the second side wall 4300d of interface 4300 includes mounting element 4308, e.g., a channel, configured and dimensioned to interact with the connecting members 750. As described above with respect to earlier embodiments (e.g., see FIG. 2), the connecting members 750 are provided to be attached to the interface 4300 and to mate the interface 4300 to the frame 1050 so that the interface 4300 can flex and move when installing the main conductor 800 and the tap conductor 810 into the connector 1000, as described above with respect to FIGS. 12-17.

An interface according to another illustrative embodiment of the present disclosure is shown in FIG. 11U and is referred to herein as interface 4400. Interface 4400 has a first side wall 4400c which includes a first side wall portion 4400f which extends from tab 4402 at an angle “S” greater than 90 degrees similar to that discussed above with respect to FIG. 11R. The angle “S” may generally between 90 and 135 degrees. First side wall portion 4400f of first side wall 4400c then transitions to upper portion 4400g which is parallel to second side wall 4400d. Upper portion 4400g then extends at an angle to portion 4400h which transitions to contact surface 4404 as shown. A bottom portion 4400e of the second side wall 4400d is flat and extends at an angle from second side wall 4400d. According to this embodiment, the bottom portion 4400e of the second side wall 4400d extends below an imaginary line extending from a lower side 4402a of tab 4402. Bottom portion 4400e may be configured to conform to the contact surface 644 of the wedge and is arranged so that as the wedge tightens the conductors 800 and 810 directly and/or indirectly to the frame 1050, the contact surface 644 of the wedge 622 does not interfere with the operation of the interface 4400, as shown and described above with respect to earlier embodiments. A tab 4402 may extend from either the first side wall 4400c or the second side wall 4400d of the interface 4400. According to the present illustrative embodiment, the lower side 4402a of tab 4402 extends into and forms a portion of contact surface 4406. Preferably, the tab 4402 extends from a lower portion of the side wall 4400c so that the tab 4402 is substantially perpendicular to at least a portion of the side wall 4400c. It is noted however, that the tab 4402 may be at a non-perpendicular angle relative to the side wall 4400c. Tab 4402 may also act as a lead-in for inserting a tap conductor between the contact surface 644 of the wedge 622 and a contact surface 4406 formed in a lower surface of the interface 4400. More specifically, when a force applied by the tap conductor 810 to tab 4402, the tab acting as a lead-in radially flexes toward the conductor contact wall 682 of the frame 1050 extending the leg 754 of the connecting member 750. The tab 4402 may have an aperture (not shown) configured to interact with an extendible reach tool.

An upper portion 4400i of second side wall 4400d extends at an angle from second side wall 4400d and transitions to contact surface 4404. It is noted that in this embodiment, because of the angled portions (4400h, 4200i) which connect the contact surface 4404 to the first side wall 4400c and second side wall 4400d, the contact surface 4404 is narrower than that depicted in other embodiments. The contact surface 4404 is configured and dimensioned to receive or fit at least partially around a main conductor 800 and is also suitable for use with conductors in the smaller range. The contact surface 4406 is formed in a lower surface of the interface 4400. The contact surface 4406 includes an optional bump 4406a which extends across at least a portion of the length “L6” of the interface 4400 and preferably across the entire length “L6” of the interface 4400. The contact surface 4406 is configured and dimensioned to receive or fit at least partially around a tap conductor 810. As described above with respect to earlier embodiments, the contact surface 4406 may also be configured and dimensioned to form a gap “G4” between the contact surface 4406 and the top wall 636 of the wedge 622 and a gap “G5” between the bump 4406a and the contact surface 644 as shown and described above with respect to FIG. 6. The gap “G4” is provided so that at least a portion of the contact surface 4406 does not contact the top wall 636 of the wedge 622 when tightening the wedge 622 to the frame 1050. Optional bump 4406a is dimensioned and positioned on contact surface 4406 so that the gap “G5” also assures that the bump 4406a does not contact the contact surface 644 of the wedge 622 when tightening the wedge 622 to the frame 1050. The contact surface 4406 may also be configured and dimensioned to urge or push the tap conductor 810, especially smaller size tap conductors, in a direction “C” so that a larger surface area of the tap conductor 810 contacts the contact surface 4406 and urges the tap conductor 810 toward bump 4406a of the interface 4400, similar to that shown and described above with respect to FIGS. 4-6. As the tap conductor 810 is being pressed between the contact surface 4406 and the contact surface 644 of the wedge 622, the bump 4406a will prevent or limit potential unraveling of the strands from the tap conductor 810. As a non-limiting example, the shape of the contact surface 4406 can be considered to have two concave arcuate surfaces with different radii and a convex arcuate raised bump 4406a similar to that described above. According to this embodiment, a first of the two concave arcuate surfaces is substantially straight and extends from the lower side 4402a of tab 4402. As depicted in various embodiments described herein the differences in radii of the two concave arcuate surfaces may be substantially the same or may be different. For example, according to the present embodiment, the radii of the two concave arcuate surfaces are substantially different. In any of the described embodiments, the radii and their center points may be set sufficient to form the desired gap “G4” between the contact surface 4406 and the top wall 636 of the wedge 622. A factor that determines the size of the gap “G4” and thus the radii as well as the positioning and dimensions of the raised bump 4406a includes the size or size range of the tap conductors 810 the interface 4400 is designed to connect to.

Either the first side wall 4400c or the second side wall 4400d of interface 4400 includes mounting element 4408, e.g., a channel, configured and dimensioned to interact with the connecting members 750. As described above with respect to earlier embodiments (e.g., see FIG. 2), the connecting members 750 are provided to be attached to the interface 4400 and to mate the interface 4400 to the frame 1050 so that the interface 4400 can flex and move when installing the main conductor 800 and the tap conductor 810 into the connector 1000, as described above with respect to FIGS. 12-17.

An interface according to another illustrative embodiment of the present disclosure is shown in FIG. 11V and is referred to herein as interface 4500. Interface 4500 has a first side wall 4500c which includes a first side wall portion 4500f which extends from tab 4502 at an angle “S” greater than 90 degrees similar to that discussed above with respect to FIG. 11R. The angle “S” may generally between 90 and 135 degrees. First side wall portion 4500f of first side wall 4500c then transitions to upper portion 4500g which is parallel to second side wall 4500d. Upper portion 4500g then extends at an angle to portion 4500f which transitions to contact surface 4504 as shown. A bottom portion 4500e of the second side wall 4500d is flat and substantially shorter than other embodiments such as those depicted in FIGS. 11S, 11v, 11W, etc.) and extends at an angle from second side wall 4500d. According to this embodiment, the bottom portion 4500e of the second side wall 4500d extends below an imaginary line extending from a lower side 4502a of tab 4502. Bottom portion 4500e may be configured to conform to the contact surface 644 of the wedge and is arranged so that as the wedge tightens the conductor directly and/or indirectly to the frame 1050, the contact surface 644 of the wedge 622 does not interfere with the operation of the interface 4500, as shown and described above with respect to earlier embodiments. A tab 4502 may extend from either the first side wall 4500c or the second side wall 4500d of the interface 4500. Preferably, the tab 4502 extends from a lower portion of the side wall 4500c so that the tab 4502 is substantially perpendicular to at least a portion of the side wall 4500c. It is noted however, that the tab 4502 may be at a non-perpendicular angle relative to the side wall 4500c. Tab 4502 may also act as a lead-in for inserting a tap conductor between the contact surface 644 of the wedge 622 and a contact surface 4506 formed in a lower surface of the interface 4500. More specifically, when a force applied by the tap conductor 810 to tab 4502, the tab acting as a lead-in radially flexes toward the conductor contact wall 682 of the frame 1050 extending the leg 754 of the connecting member 750. The tab 4502 may have an aperture (not shown) configured to interact with an extendible reach tool.

The contact surface 4504 is configured and dimensioned to receive or fit at least partially around a main conductor 800. It is noted that in this embodiment, because of the angled portion (4500i) which connects the contact surface 4504 to the second side wall 4500d, the contact surface 4504 is narrower than that depicted in other embodiments. The contact surface 4504 is configured and dimensioned to receive or fit at least partially around a main conductor 800 and is also suitable for use with conductors 810 in the smaller range. A contact surface 4506 is formed in a lower surface of the interface 4500. The contact surface 4506 includes an optional bump 4506a which extends across at least a portion of the length “L6” of the interface 4500 and preferably across the entire length “L6” of the interface 4500. The contact surface 4506 is configured and dimensioned to receive or fit at least partially around a tap conductor 810. As described above with respect to earlier embodiments, the contact surface 4506 may also be configured and dimensioned to form a gap “G4” between the contact surface 4506 and the top wall 636 of the wedge 622 and a gap “G5” between the bump 4506a and the contact surface 644 as shown and described above with respect to FIG. 6. The gap “G4” is provided so that at least a portion of the contact surface 4506 does not contact the top wall 636 of the wedge 622 when tightening the wedge 622 to the frame 1050. Optional bump 4506a is dimensioned and positioned on contact surface 4506 so that the gap “G5” also assures that the bump 4506a does not contact the contact surface 644 of the wedge 622 when tightening the wedge 622 to the frame 1050. The contact surface 4506 may also be configured and dimensioned to urge or push the tap conductor 810, especially smaller size tap conductors, in a direction “C” so that a larger surface area of the tap conductor 810 contacts the contact surface 4506 and urges the tap conductor 810 toward bump 4506a of the interface 4500, similar to that shown and described above with respect to FIGS. 4-6. As the tap conductor 810 is being pressed between the contact surface 4506 and the contact surface 644 of the wedge 622, the bump 4506a will prevent or limit potential unraveling of the strands from the tap conductor 810. As a non-limiting example, the shape of the contact surface 4506 can be considered to have two concave arcuate surfaces with different radii and a convex arcuate raised bump 4506a similar to that described above. As depicted in various embodiments described herein the differences in radii of the two concave arcuate surfaces may be substantially the same or may be different. The convex arcuate raised bump 4506a protrudes from a portion of the contact surface 4506 generally associated with Arc 10 (e.g., see FIG. 9). In any of the described embodiments, the radii and their center points may be set sufficient to form the desired gap “G4” between the contact surface 4506 and the top wall 636 of the wedge 622. A factor that determines the size of the gap “G4” and thus the radii as well as the positioning and dimensions of the raised bump 4506a includes the size or size range of the tap conductors 810 the interface 4500 is designed to connect to.

Either the first side wall 4500c or the second side wall 4500d of interface 4500 includes mounting element 4508, e.g., a channel, configured and dimensioned to interact with the connecting members 750. As described above with respect to earlier embodiments (e.g., see FIG. 2), the connecting members 750 are provided to be attached to the interface 4500 and to mate the interface 4500 to the frame 1050 so that the interface 4500 can flex and move when installing the main conductor 800 and the tap conductor 810 into the connector 1000, as described above with respect to FIGS. 12-17.

An interface according to another illustrative embodiment of the present disclosure is shown in FIG. 11W and is referred to herein as interface 4600. Interface 4600 has a first side wall 4600c which includes a first side wall portion 4600f which extends from tab 4602 at an angle “S” greater than 90 degrees similar to that discussed above with respect to FIG. 11R. The angle “S” may generally between 90 and 135 degrees. First side wall portion 4600f of first side wall 4600c then transitions to upper portion 4600g which is parallel to second side wall 4600d. Upper portion 4600g then extends at an angle to portion 4600h which transitions to contact surface 4604 as shown. A bottom portion 4600e of the second side wall 4600d is flat and extends at an angle from second side wall 4600d. According to this embodiment, the bottom portion 4600e of the second side wall 4600d may extend slightly below an imaginary line extending from a lower side 4602a of tab 4602. Bottom portion 4600e may be configured to conform to the contact surface 644 of the wedge and is arranged so that as the wedge tightens the conductor directly and/or indirectly to the frame 1050, the contact surface 644 of the wedge 622 does not interfere with the operation of the interface 4600, as shown and described above with respect to earlier embodiments. A tab 4602 may extend from either the first side wall 4600c or the second side wall 4600d of the interface 4600. Preferably, the tab 4602 extends from a lower portion of the side wall 4600c so that the tab 4602 is substantially perpendicular to at least a portion of the side wall 4600c. It is noted however, that the tab 4602 may be at a non-perpendicular angle relative to the side wall 4600c. Tab 4602 may also act as a lead-in for inserting a tap conductor between the contact surface 644 of the wedge 622 and a contact surface 4606 formed in a lower surface of the interface 4600. More specifically, when a force applied by the tap conductor 810 to tab 4602, the tab acting as a lead-in radially flexes toward the conductor contact wall 682 of the frame 1050 extending the leg 754 of the connecting member 750. The tab 4602 may have an aperture (not shown) configured to interact with an extendible reach tool.

The contact surface 4604 is configured and dimensioned to receive or fit at least partially around a main conductor 800. It is noted that in this embodiment, because of the angled portions (4600h, 4600i) which connect the contact surface 4604 to the first side wall 4600C and second side wall 4600d, the contact surface 4604 is narrower than that depicted in other embodiments. The contact surface 4604 is configured and dimensioned to receive or fit at least partially around a main conductor 800 and is also suitable for use with conductors in the smaller range. A contact surface 4606 is formed in a lower surface of the interface 4600. The contact surface 4606 includes an optional bump 4606a which extends across at least a portion of the length “L6” of the interface 4600 and preferably across the entire length “L6” of the interface 4600. The contact surface 4606 is configured and dimensioned to receive or fit at least partially around a tap conductor 810. As described above with respect to earlier embodiments, the contact surface 4606 may also be configured and dimensioned to form a gap “G4” between the contact surface 4606 and the top wall 636 of the wedge 622 and a gap “G5” between the bump 4606a and the contact surface 644 as shown and described above with respect to FIG. 6. The gap “G4” is provided so that at least a portion of the contact surface 4606 does not contact the top wall 636 of the wedge 622 when tightening the wedge 622 to the frame 1050. Optional bump 4606a is dimensioned and positioned on contact surface 4606 so that the gap “G5” also assures that the bump 4506a does not contact the contact surface 644 of the wedge 622 when tightening the wedge 622 to the frame 1050. The contact surface 4606 may also be configured and dimensioned to urge or push the tap conductor 810, especially smaller size tap conductors, in a direction “C” so that a larger surface area of the tap conductor 810 contacts the contact surface 4606 and urges the tap conductor 810 toward bump 4606a of the interface 4600, similar to that shown and described above with respect to FIGS. 4-6. As the tap conductor 810 is being pressed between the contact surface 4606 and the contact surface 644 of the wedge 622, the bump 4506a will prevent or limit potential unraveling of the strands from the tap conductor 810. As a non-limiting example, the shape of the contact surface 4606 can be considered to have two concave arcuate surfaces with different radii and a convex arcuate raised bump 4606a similar to that described above. As depicted in various embodiments described herein the differences in radii of the two concave arcuate surfaces may be substantially the same or may be different. The convex arcuate raised bump 4606a protrudes from a portion of the contact surface 4606 generally associated with Arc 10 (e.g., see FIG. 9). In any of the described embodiments, the radii and their center points may be set sufficient to form the desired gap “G4” between the contact surface 4606 and the top wall 636 of the wedge 622. A factor that determines the size of the gap “G4” and thus the radii as well as the positioning and dimensions of the raised bump 4606a includes the size or size range of the tap conductors 810 the interface 4600 is designed to connect to.

Either the first side wall 4600c or the second side wall 4600d of interface 4600 includes mounting element 4608, e.g., a channel, configured and dimensioned to interact with the connecting members 750. As described above with respect to earlier embodiments (e.g., see FIG. 2), the connecting members 750 are provided to be attached to the interface 4600 and to mate the interface 4600 to the frame 1050 so that the interface 4600 can flex and move when installing the main conductor 800 and the tap conductor 810 into the connector 1000, as described above with respect to FIGS. 12-17.

An interface according to another illustrative embodiment of the present disclosure is shown in FIG. 11X and is referred to herein as interface 4700. Interface 4700 has a first side wall 4700c which includes a first side wall portion 4700f which extends from tab 4702 at an angle “S” greater than 90 degrees similar to that discussed above with respect to FIG. 11R. The angle “S” may generally between 90 and 135 degrees. First side wall portion 4700f of first side wall 4700c then transitions to upper portion 4700g which is parallel to second side wall 4700d. Upper portion 4700g then extends at an angle to portion 4700f which transitions to contact surface 4704 as shown. A bottom portion 4700e of the second side wall 4700d is flat and extends at an angle from second side wall 4700d. According to this embodiment, the bottom portion 4700e of the second side wall 4700d extends below an imaginary line extending from a lower side 4702a of tab 4702. Bottom portion 4700e may be configured to conform to the contact surface 644 of the wedge and is arranged so that as the wedge tightens the conductor directly and/or indirectly to the frame 1050, the contact surface 644 of the wedge 622 does not interfere with the operation of the interface 4700, as shown and described above with respect to earlier embodiments. A tab 4702 may extend from either the first side wall 4700c or the second side wall 4700d of the interface 4700. Preferably, the tab 4702 extends from a lower portion of the side wall 4700c so that the tab 4702 is substantially perpendicular to at least a portion of the side wall 4700c. It is noted however, that the tab 4702 may be at a non-perpendicular angle relative to the side wall 4700c. Tab 4702 may also act as a lead-in for inserting a tap conductor between the contact surface 644 of the wedge 622 and a contact surface 4706 formed in a lower surface of the interface 4700. More specifically, when a force applied by the tap conductor 810 to tab 4702, the tab acting as a lead-in radially flexes toward the conductor contact wall 682 of the frame 1050 extending the leg 754 of the connecting member 750. The tab 4702 may have an aperture (not shown) configured to interact with an extendible reach tool.

The contact surface 4704 is configured and dimensioned to receive or fit at least partially around a main conductor 800. A contact surface 4706 is formed in a lower surface of the interface 4700. The contact surface 4706 includes an optional bump 4706a which extends across at least a portion of the length “L6” of the interface 4700 and preferably across the entire length “L6” of the interface 4700. The contact surface 4706 is configured and dimensioned to receive or fit at least partially around a tap conductor 810. As described above with respect to earlier embodiments, the contact surface 4706 may also be configured and dimensioned to form a gap “G4” between the contact surface 4706 and the top wall 636 of the wedge 622 and a gap “G5” between the bump 4706a and the contact surface 644 as shown and described above with respect to FIG. 6. The gap “G4” is provided so that at least a portion of the contact surface 4706 does not contact the top wall 636 of the wedge 622 when tightening the wedge 622 to the frame 1050. Optional bump 4706a is dimensioned and positioned on contact surface 4706 so that the gap “G5” also assures that the bump 4706a does not contact the contact surface 644 of the wedge 622 when tightening the wedge 622 to the frame 1050. The contact surface 4706 may also be configured and dimensioned to urge or push the tap conductor 810, especially smaller size tap conductors, in a direction “C” so that a larger surface area of the tap conductor 810 contacts the contact surface 4706 and urges the tap conductor 810 toward bump 4706a of the interface 4700, similar to that shown and described above with respect to FIGS. 4-6. As the tap conductor 810 is being pressed between the contact surface 4706 and the contact surface 644 of the wedge 622, the bump 4706a will prevent or limit potential unraveling of the strands from the tap conductor 810. As a non-limiting example, the shape of the contact surface 4706 can be considered to have two concave arcuate surfaces with different radii and a convex arcuate raised bump 4706a similar to that described above. As depicted in various embodiments described herein the differences in radii of the two concave arcuate surfaces may be substantially the same or may be different. The convex arcuate raised bump 4706a protrudes from a portion of the contact surface 4706 generally associated with Arc 10 (e.g., see FIG. 9). In any of the described embodiments, the radii and their center points may be set sufficient to form the desired gap “G4” between the contact surface 4706 and the top wall 636 of the wedge 622. A factor that determines the size of the gap “G4” and thus the radii as well as the positioning and dimensions of the raised bump 4706a includes the size or size range of the tap conductors 810 the interface 4700 is designed to connect to.

Either the first side wall 4700c or the second side wall 4700d of interface 4700 includes mounting element 4708, e.g., a channel, configured and dimensioned to interact with the connecting members 750. As described above with respect to earlier embodiments (e.g., see FIG. 2), the connecting members 750 are provided to be attached to the interface 4700 and to mate the interface 4700 to the frame 1050 so that the interface 4700 can flex and move when installing the main conductor 800 and the tap conductor 810 into the connector 1000, as described above with respect to FIGS. 12-17.

An interface according to another illustrative embodiment of the present disclosure is shown in FIG. 11Y and is referred to herein as interface 4800. Interface 4800 has a first side wall 4800c which includes a first side wall portion 4800f which extends from tab 4802 at an angle “S” greater than 90 degrees similar to that discussed above with respect to FIG. 11R. The angle “S” may generally between 90 and 135 degrees. First side wall portion 4800f of first side wall 4800c then transitions to upper portion 4800g which is parallel to second side wall 4800d. Upper portion 4800g then extends at an angle to portion 4800h which transitions to contact surface 4804 as shown. A bottom portion 4800e of the second side wall 4800d is flat and substantially shorter and comes to more of a point when transitioning to contact surface 4806 than other embodiments such as those depicted in FIGS. 11S, 11v, 11W, etc. Bottom portion 4800e also extends at a relatively shallower angle from second side wall 4800d than previous embodiments. According to this embodiment, the bottom portion 4800e of the second side wall 4800d extends below an imaginary line extending from a lower side 4802a of tab 4802. Bottom portion 4800e may be configured to conform to the contact surface 644 of the wedge and is arranged so that as the wedge tightens the conductor directly and/or indirectly to the frame 1050, the contact surface 644 of the wedge 622 does not interfere with the operation of the interface 4800, as shown and described above with respect to earlier embodiments. A tab 4802 may extend from either the first side wall 4800c or the second side wall 4800d of the interface 4800. Preferably, the tab 4802 extends from a lower portion of the side wall 4800c so that the tab 4802 is substantially perpendicular to at least a portion of the side wall 4800c. It is noted however, that the tab 4802 may be at a non-perpendicular angle relative to the side wall 4800c. Tab 4802 may also act as a lead-in for inserting a tap conductor between the contact surface 644 of the wedge 622 and a contact surface 4806 formed in a lower surface of the interface 4800. More specifically, when a force applied by the tap conductor 810 to tab 4802, the tab acting as a lead-in radially flexes toward the conductor contact wall 682 of the frame 1050 extending the leg 754 of the connecting member 750. The tab 4802 may have an aperture (not shown) configured to interact with an extendible reach tool.

The contact surface 4804 is configured and dimensioned to receive or fit at least partially around a main conductor 800. It is noted that in this embodiment, the upper portion of second side wall 4800d extends higher than portion 4800h of first side wall 4800c. The contact surface 4804 is configured and dimensioned to receive or fit at least partially around a main conductor 800. A contact surface 4806 is formed in a lower surface of the interface 4800. The contact surface 4806 includes an optional bump 4806a which extends across at least a portion of the length “L6” of the interface 4800 and preferably across the entire length “L6” of the interface 4800. The contact surface 4806 is configured and dimensioned to receive or fit at least partially around a tap conductor 810. As described above with respect to earlier embodiments, the contact surface 4806 may also be configured and dimensioned to form a gap “G4” between the contact surface 4806 and the top wall 636 of the wedge 622 and a gap “G5” between the bump 4806a and the contact surface 644 as shown and described above with respect to FIG. 6. The gap “G4” is provided so that at least a portion of the contact surface 4806 does not contact the top wall 636 of the wedge 622 when tightening the wedge 622 to the frame 1050. Optional bump 4806a is dimensioned and positioned on contact surface 4506 so that the gap “G5” also assures that the bump 4806a does not contact the contact surface 644 of the wedge 622 when tightening the wedge 622 to the frame 1050. The contact surface 4806 may also be configured and dimensioned to urge or push the tap conductor 810, especially smaller size tap conductors, in a direction “C” so that a larger surface area of the tap conductor 810 contacts the contact surface 4806 and urges the tap conductor 810 toward bump 4806a of the interface 4800, similar to that shown and described above with respect to FIGS. 4-6. As the tap conductor 810 is being pressed between the contact surface 4806 and the contact surface 644 of the wedge 622, the bump 4806a will prevent or limit potential unraveling of the strands from the tap conductor 810. As a non-limiting example, the shape of the contact surface 4806 can be considered to have two concave arcuate surfaces with different radii and a convex arcuate raised bump 4806a similar to that described above. As depicted in various embodiments described herein the differences in radii of the two concave arcuate surfaces may be substantially the same or may be different. The convex arcuate raised bump 4806a protrudes from a portion of the contact surface 4806 generally associated with Arc 10 (e.g., see FIG. 9). In any of the described embodiments, the radii and their center points may be set sufficient to form the desired gap “G4” between the contact surface 4806 and the top wall 636 of the wedge 622. A factor that determines the size of the gap “G4” and thus the radii as well as the positioning and dimensions of the raised bump 4806a includes the size or size range of the tap conductors 810 the interface 4800 is designed to connect to.

Either the first side wall 4800c or the second side wall 4800d of interface 4800 includes mounting element 4808, e.g., a channel, configured and dimensioned to interact with the connecting members 750. As described above with respect to earlier embodiments (e.g., see FIG. 2), the connecting members 750 are provided to be attached to the interface 4500 and to mate the interface 4800 to the frame 1050 so that the interface 4800 can flex and move when installing the main conductor 800 and the tap conductor 810 into the connector 1000, as described above with respect to FIGS. 12-17.

An interface according to another illustrative embodiment of the present disclosure is shown in FIG. 11Z and is referred to herein as interface 4900. Interface 4900 has a first side wall 4900c which includes a first side wall portion 4900f which extends from tab 4902 at an angle “S” greater than 90 degrees similar to that discussed above with respect to FIG. 11R. The angle “S” may generally between 90 and 135 degrees. First side wall portion 4900f of first side wall 4900c then transitions to upper portion 4900g which is parallel to second side wall 4900d. Upper portion 4900g then extends at an angle to portion 4900f which transitions to contact surface 4904 as shown. A bottom portion 4900e of the second side wall 4900d is flat and extends at an angle from second side wall 4900d. According to this embodiment, the bottom portion 4900e of the second side wall 4900d extends slightly below an imaginary line extending from a lower side 4902a of tab 4902. Bottom portion 4900e may be configured to conform to the contact surface 644 of the wedge and is arranged so that as the wedge tightens the conductor directly and/or indirectly to the frame 1050, the contact surface 644 of the wedge 622 does not interfere with the operation of the interface 4900, as shown and described above with respect to earlier embodiments. A tab 4902 may extend from either the first side wall 4900c or the second side wall 4900d of the interface 4900. Preferably, the tab 4902 extends from a lower portion of the side wall 4900c so that the tab 4902 is substantially perpendicular to at least a portion of the side wall 4900c. It is noted however, that the tab 4902 may be at a non-perpendicular angle relative to the side wall 4900c. Tab 4902 may also act as a lead-in for inserting a tap conductor between the contact surface 644 of the wedge 622 and a contact surface 4906 formed in a lower surface of the interface 4900. More specifically, when a force applied by the tap conductor 810 to tab 4902, the tab acting as a lead-in radially flexes toward the conductor contact wall 682 of the frame 1050 extending the leg 754 of the connecting member 750. The tab 4902 may have an aperture (not shown) configured to interact with an extendible reach tool.

The contact surface 4904 is configured and dimensioned to receive or fit at least partially around a main conductor 800. It is noted that in this embodiment, because of the angled portions (4900h and 4900i) which connects the contact surface 4504 to the first side wall 4900c an second side wall 4900d, the contact surface 4904 is narrower than that depicted in other embodiments. The contact surface 4904 is configured and dimensioned to receive or fit at least partially around a main conductor 800 and is also suitable for use with tap conductors 810 in the smaller range. A contact surface 4906 is formed in a lower surface of the interface 4900. The contact surface 4906 includes an optional bump 4906a which extends across at least a portion of the length “L6” of the interface 4900 and preferably across the entire length “L6” of the interface 4900. The contact surface 4906 is configured and dimensioned to receive or fit at least partially around a tap conductor 810. As described above with respect to earlier embodiments, the contact surface 4906 may also be configured and dimensioned to form a gap “G4” between the contact surface 4906 and the top wall 636 of the wedge 622 and a gap “G5” between the bump 4906a and the contact surface 644 as shown and described above with respect to FIG. 6. The gap “G4” is provided so that at least a portion of the contact surface 4906 does not contact the top wall 636 of the wedge 622 when tightening the wedge 622 to the frame 1050. Optional bump 4906a is dimensioned and positioned on contact surface 4906 so that the gap “G5” also assures that the bump 4906a does not contact the contact surface 644 of the wedge 622 when tightening the wedge 622 to the frame 1050. The contact surface 4906 may also be configured and dimensioned to urge or push the tap conductor 810, especially smaller size tap conductors, in a direction “C” so that a larger surface area of the tap conductor 810 contacts the contact surface 4906 and urges the tap conductor 810 toward bump 4906a of the interface 4900, similar to that shown and described above with respect to FIGS. 4-6. As the tap conductor 810 is being pressed between the contact surface 4906 and the contact surface 644 of the wedge 622, the bump 4906a will prevent or limit potential unraveling of the strands from the tap conductor 810. As a non-limiting example, the shape of the contact surface 4906 can be considered to have two concave arcuate surfaces with different radii and a convex arcuate raised bump 4506a similar to that described above. As depicted in various embodiments described herein the differences in radii of the two concave arcuate surfaces may be substantially the same or may be different. The convex arcuate raised bump 4906a protrudes from a portion of the contact surface 4906 generally associated with Arc 10 (e.g., see FIG. 9). In any of the described embodiments, the radii and their center points may be set sufficient to form the desired gap “G4” between the contact surface 4906 and the top wall 636 of the wedge 622. A factor that determines the size of the gap “G4” and thus the radii as well as the positioning and dimensions of the raised bump 4906a includes the size or size range of the tap conductors 810 the interface 4900 is designed to connect to.

Either the first side wall 4900c or the second side wall 4900d of interface 4900 includes mounting element 4908, e.g., a channel, configured and dimensioned to interact with the connecting members 750. As described above with respect to earlier embodiments (e.g., see FIG. 2), the connecting members 750 are provided to be attached to the interface 4500 and to mate the interface 4900 to the frame 1050 so that the interface 4900 can flex and move when installing the main conductor 800 and the tap conductor 810 into the connector 1000, as described above with respect to FIGS. 12-17.

An interface according to another illustrative embodiment of the present disclosure is shown in FIG. 11Z1 and is referred to herein as interface 5100. Interface 5100 has a first side wall 5100c which includes a first side wall portion 5100f which extends from tab 5102 at an angle “S” greater than 90 degrees similar to that discussed above with respect to FIG. 11R. The angle “S” may generally between 90 and 135 degrees. First side wall portion 5100f of first side wall 5100c then transitions to upper portion 5100g which is parallel to second side wall 5100d. Upper portion 5100g then extends at an angle to portion 5100f which transitions to contact surface 5104 as shown. A bottom portion 5100e of the second side wall 5100d is flat and extends at an angle from second side wall 5100d. According to this embodiment, the bottom portion 5100e of the second side wall 5100d extends below an imaginary line extending from a lower side 5102a of tab 5102. Bottom portion 5100e may be configured to conform to the contact surface 644 of the wedge and is arranged so that as the wedge tightens the conductor directly and/or indirectly to the frame 1050, the contact surface 644 of the wedge 622 does not interfere with the operation of the interface 5100, as shown and described above with respect to earlier embodiments. A tab 5102 may extend from either the first side wall 5100c or the second side wall 5100d of the interface 5100. Preferably, the tab 5102 extends from a lower portion of the side wall 5100c so that the tab 5102 is substantially perpendicular to at least a portion of the side wall 5100c. It is noted however, that the tab 5102 may be at a non-perpendicular angle relative to the side wall 5100c. Tab 5102 may also act as a lead-in for inserting a tap conductor between the contact surface 644 of the wedge 622 and a contact surface 5106 formed in a lower surface of the interface 5100. More specifically, when a force applied by the tap conductor 810 to tab 5102, the tab acting as a lead-in radially flexes toward the conductor contact wall 682 of the frame 1050 extending the leg 754 of the connecting member 750. The tab 5102 may have an aperture (not shown) configured to interact with an extendible reach tool.

The contact surface 5104 is configured and dimensioned to receive or fit at least partially around a main conductor 800. It is noted that in this embodiment, the upper portion of second side wall 5100d extends higher than portion 5100h of first side wall 5100c. The contact surface 5104 is configured and dimensioned to receive or fit at least partially around a main conductor 800. A contact surface 5106 is formed in a lower surface of the interface 5100. The contact surface 5106 includes an optional bump 5106a which extends across at least a portion of the length “L6” of the interface 5100 and preferably across the entire length “L6” of the interface 5100. The contact surface 5106 is configured and dimensioned to receive or fit at least partially around a tap conductor 810. As described above with respect to earlier embodiments, the contact surface 5106 may also be configured and dimensioned to form a gap “G4” between the contact surface 5106 and the top wall 636 of the wedge 622 and a gap “G5” between the bump 5106a and the contact surface 644 as shown and described above with respect to FIG. 6. The gap “G4” is provided so that at least a portion of the contact surface 5106 does not contact the top wall 636 of the wedge 622 when tightening the wedge 622 to the frame 1050. Optional bump 5106a is dimensioned and positioned on contact surface 5106 so that the gap “G5” also assures that the bump 5106a does not contact the contact surface 644 of the wedge 622 when tightening the wedge 622 to the frame 1050. The contact surface 5106 may also be configured and dimensioned to urge or push the tap conductor 810, especially smaller size tap conductors, in a direction “C” so that a larger surface area of the tap conductor 810 contacts the contact surface 5106 and urges the tap conductor 810 toward bump 5106a of the interface 5100, similar to that shown and described above with respect to FIGS. 4-6. As the tap conductor 810 is being pressed between the contact surface 5106 and the contact surface 644 of the wedge 622, the bump 5106a will prevent or limit potential unraveling of the strands from the tap conductor 810. As a non-limiting example, the shape of the contact surface 5106 can be considered to have two concave arcuate surfaces with different radii and a convex arcuate raised bump 5106a similar to that described above. As depicted in various embodiments described herein the differences in radii of the two concave arcuate surfaces may be substantially the same or may be different. The convex arcuate raised bump 5106a protrudes from a portion of the contact surface 5106 generally associated with Arc 10 (e.g., see FIG. 9). In any of the described embodiments, the radii and their center points may be set sufficient to form the desired gap “G4” between the contact surface 5106 and the top wall 636 of the wedge 622. A factor that determines the size of the gap “G4” and thus the radii as well as the positioning and dimensions of the raised bump 5106a includes the size or size range of the tap conductors 810 the interface 5100 is designed to connect to.

Either the first side wall 5100c or the second side wall 5100d of interface 5100 includes mounting element 5108, e.g., a channel, configured and dimensioned to interact with the connecting members 750. As described above with respect to earlier embodiments (e.g., see FIG. 2), the connecting members 750 are provided to be attached to the interface 5100 and to mate the interface 5100 to the frame 1050 so that the interface 5100 can flex and move when installing the main conductor 800 and the tap conductor 810 into the connector 1000, as described above with respect to FIGS. 12-17.

The above-described embodiments may be characterized in various ways. For example, interface 2200 depicted in FIG. 11A does not need a tab lead-in as it is symmetric about line X-X. Portions 2200g and 2200g′ may serve as lead-ins for the small conductor sizes this interface is intended to accommodate.

The various interfaces depicted in FIGS. 11B, 11C, 11D, 11F, 11S, 11T, 11V, 11X, 11Y, 11Z and 11Z1 include tabs which protrude outward from a position where the lower surface of the tab is below the tangent of R10 and intersects with an angled portion (e.g., see FIG. 11B, portion 2300f). This tab position allows for extended swoop i.e. R10 & R20 and thus extended lead-in. The angled portions (e.g., portion 2300f) are provided to allow sufficient wall thickness back to the main portion of interface body rather than extending body out further, thus saving material and manufacturing costs.

The embodiment depicted in FIG. 11U is similar in some respects to those depicted in other embodiments except that the lower surface of tab (e.g., see FIG. 11G, portion 2802A) intersects the tangent of R10. Such a design is particularly suitable for use with smaller tap conductors to allow the interface to close fully onto the tap.

The embodiments depicted in FIGS. 11E, 11P, 11Q include tabs which protrude outward from a position where the lower surface of the tab is below the tangent of R10 and intersects with flat face such as 2100c. These embodiments may in addition to being suitable for use with smaller tap conductors, are suitable for use with larger size run conductors and larger size tap conductors to allow sufficient lead-in for tap and also capture the tap conductor adequately.

The embodiments depicted in FIGS. 11G, 11H, 11I, 11J, 11K, 11L, 11M, 11N and 11O are similar to other embodiments except that the lower surface of tab (e.g., see FIG. 11G, portion 2802A) intersects the tangent of R10. Such a design is particularly suitable for use with small tap conductors to allow the interface to close fully onto the tap.

The embodiment depicted in FIG. 11R includes the angled portion 4100c. This design requires less material than some other embodiments and saves material and manufacturing costs.

Certain terminology may be used in the present disclosure for ease of description and understanding. Examples include the following terminology or variations thereof: top, bottom, up, upward, upper, inner, outer, outward, down, downward, upper, lower, vertical, horizontal, etc. These terms refer to directions in the drawings to which reference is being made and not necessarily to any actual configuration of the structure or structures in use and, as such, are not necessarily meant to be limiting.

As shown throughout the drawings, like reference numerals designate like or similar corresponding parts. While illustrative embodiments of the present disclosure have been described and illustrated above, it should be understood that these are exemplary of the disclosure and are not to be considered as limiting. Various portions of the described embodiments may be mixed and matched depending on a particular application. Additions, deletions, substitutions, and other modifications can be made without departing from the spirit or scope of the present disclosure. Accordingly, the present disclosure is not to be considered as limited by the foregoing description.

While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

The wedge assembly and interfaces described herein may be made of an electrically conductive material that has sufficient rigidity to withstand the forces applied by the wedge assembly against the frame when mechanically connecting the main conductor 800 to a tap conductor 810. Non-limiting examples of such electrically conductive and rigid materials include aluminum, aluminum alloys, stainless steel, galvanized steel, copper and copper/brass alloys. The one or more connecting members described herein may also be made of an electrically conductive material or a non-conductive material. Non-limiting examples of such electrically conductive materials include aluminum, aluminum alloys, stainless steel, galvanized steel, copper and copper/brass alloys described above. Non-limiting examples of such non-conductive materials include plastic materials and elastomeric materials. For example, the one or more connecting members may be made of Ethylene Propylene Diene Monomer (EPDM), Thermoplastic Elastomer (Rubber TPE) or Silicone.

What is claimed is:

1. An interface for use with a wedge type cable connector, the interface comprising:
a body comprising first and second longitudinal side walls and upper and lower concave longitudinal contact surfaces, wherein the lower concave longitudinal contact surface comprises a convex longitudinal bump.

2. The interface according to claim 1, wherein the lower concave longitudinal contact surface comprises a first concave surface having a first radius and a second concave surface having a second radius.

3. The interface according to claim 2, wherein the first radius and the second radius are the same.

4. The interface according to claim 2, wherein the first radius and the second radius are different.

5. The interface according to claim 4 wherein the first radius is greater than the second radius.

6. The interface according to claim 5, wherein the convex longitudinal bump is provided on the first concave surface.

7. The interface according to claim 6, wherein the second concave surface serves to urge a cable toward the first concave surface.

8. The interface according to claim 7, wherein convex longitudinal bump serves to limit or prevent unraveling of strands forming the cable.

9. The interface according to claim 2, wherein a longitudinal edge of the second concave surface extends below an imaginary lateral line extending from a longitudinal edge of the first concave surface.

10. The interface according to claim 2, wherein a longitudinal edge of the second concave surface is substantially even with an imaginary lateral line extending from a longitudinal edge of the first concave surface.

11. A wedge type electrical power connector assembly comprising:
a frame having conductor contact wall, a wedge support wall, and a rear wall between the conductor contact wall and the wedge support wall and a mounting member, wherein the conductor contact wall, the wedge support wall and the rear wall form a wedge receiving channel;
a wedge assembly having a wedge and a fastener, the wedge having a body and a fastener holder, the body being shaped to fit at least partially within the wedge receiving channel of the frame, the fastener holder being aligned with the mounting member so that the fastener can pass through the fastener holder into engagement with the mounting member; and
an interface movably positioned within the wedge receiving channel, the interface comprising a body comprising first and second longitudinal side walls and upper and lower concave longitudinal contact surfaces, wherein the lower concave longitudinal contact surface comprises a convex longitudinal bump.

12. The wedge type electrical power connector assembly according to claim 11, wherein the lower concave longitudinal contact surface comprises a first concave surface having a first radius and a second concave surface having a second radius.

13. The wedge type electrical power connector assembly according to claim 12, wherein the first radius and the second radius are the same.

14. The wedge type electrical power connector assembly according to claim 12, wherein the first radius and the second radius are different.

15. The wedge type electrical power connector assembly according to claim 14 wherein the first radius is greater than the second radius.

16. The wedge type electrical power connector assembly according to claim 15, wherein the convex longitudinal bump is provided on the first concave surface.

17. The wedge type electrical power connector assembly according to claim 16, wherein the second concave surface serves to urge a cable toward the first concave surface.

18. The wedge type electrical power connector assembly according to claim 17, wherein convex longitudinal bump serves to limit or prevent unraveling of strands forming the cable.

19. The wedge type electrical power connector assembly according to claim 12, wherein a longitudinal edge of the second concave surface extends below an imaginary lateral line extending from a longitudinal edge of the first concave surface.

20. The wedge type electrical power connector assembly according to claim 12, wherein a longitudinal edge of the second concave surface is substantially even with an imaginary lateral line extending from a longitudinal edge of the first concave surface.
